(19) United States
(12) Patent Application Publication
(10) Pub. No.: US 2026/0201894 A1
(43) Pub. Date: Jul. 16, 2026

(54) PORTABLE FAN

(71) Applicant: Shenzhen Jisu Technology Co., Ltd., Shenzhen (CN)

(72) Inventors: Guanzheng Zheng, Shenzhen (CN); Xiangfu Li, Shenzhen (CN); Wenpeng Qi, Shenzhen (CN)

(73) Assignee: Shenzhen Jisu Technology Co., Ltd., Shenzhen (CN)

(21) Appl. No.: 19/551,464

(22) Filed: Feb. 26, 2026

Related U.S. Application Data
(63) Continuation of application No. PCT/CN2023/130865, filed on Nov. 9, 2023.

(30) Foreign Application Priority Data
Aug. 30, 2023 (CN) CN202322355832.2
Aug. 30, 2023 (CN) CN202322362948.9
Aug. 30, 2023 (CN) CN202322363507.0
Aug. 30, 2023 (CN) CN202322383919.0
Aug. 30, 2023 (CN) CN202322385011.3
Aug. 30, 2023 (CN) CN202322385347.X

(51) Int. Cl. F04D 25/08; F04D 19/00; F04D 25/06; F04D 29/52

(52) U.S. Cl. CPC F04D 25/084; F04D 19/002; F04D 25/0673; F04D 29/522

(57) ABSTRACT

A portable fan is disclosed, including: a first housing, where a fan assembly is arranged on the first housing; and a second housing, where the second housing is fastened onto the first housing. An edge of the first housing protrudes toward the second housing to form an insertion member, a plurality of first engaging members are arranged on the insertion member, a clamping member is arranged in the second housing, a first insertion groove is formed between the clamping member and an inner surface of the second housing, a plurality of second engaging members mating with the plurality of first engaging members are arranged on the clamping member, the insertion member is inserted into the first insertion groove, and the plurality of first engaging members are engaged with the plurality of second engaging members in a mating manner.

### CROSS-REFERENCE TO RELATED APPLICATIONS

This application is a continuation of International Application No. PCT/CN2023/130865 filed on Nov. 9, 2023, which claims priority to Chinese patent application 202322385011.3, filed on Aug. 30, 2023; and Chinese patent application 202322363507.0, filed on Aug. 30,2023; Chinese patent application 202322385347.X, filed on Aug. 30, 2023; Chinese patent application 202322383919.0, filed on Aug. 30, 2023; Chinese patent application 202322362948.9, filed on Aug. 30, 2023, and Chinese patent application 202322355832.2, filed on Aug. 30, 2023. All the above-mentioned applications are incorporated herein by reference in their entireties.

### TECHNICAL FIELD

The present application relates to the field of fans, and in particular, to a portable fan.

### BACKGROUND

In hot summers, fans have become essential appliances for users to relieve heat. With the increasing demand for convenient use, fans that are lighter and more portable have gained growing popularity.

Portable fans are favored by users due to their small size and ease of carrying. The housing of existing portable fans is generally formed by two housings fastened together. To ensure tight fastening, buckles and claws are usually provided on the inner walls of the two housings for mating engagement. However, the applicant of the present application has found in research that such a fastening structure in the prior art, in which both the buckles and claws are arranged on the surfaces of the corresponding housings, may cause deformation, bulging, or warping of the fastening portions of the housings during engagement. In such a structure, when the housing is twisted by an external force during use, the buckles and claws may become disengaged, resulting in insufficient stability of the snap-fit connection.

### SUMMARY

An object of the present application is to provide a portable fan in which buckles are arranged inside a housing, so that a snap-fit connection is more firm and stable.

An embodiment of the present application provides a portable fan, including: a first housing, where a fan assembly is arranged on the first housing; and a second housing, where the second housing is fastened onto the first housing; and an edge of the first housing protrudes toward the second housing to form an insertion member, the insertion member is provided with a plurality of first engaging members; a clamping member is arranged in the second housing, a first insertion groove is formed between the clamping member and an inner surface of the second housing, the clamping member is provided with a plurality of second engaging members mating with the plurality of first engaging members; and the insertion member is inserted into the first insertion groove, and the plurality of first engaging members are engaged with the plurality of second engaging members in a mating manner.

### BRIEF DESCRIPTION OF DRAWINGS

The foregoing and/or additional aspects and advantages of the present application will become apparent and readily understood from the following description of the embodiments in conjunction with the accompanying drawings.

FIG. 1 is a schematic diagram of an overall structure of a portable fan according to Embodiment 1 of the present application;

FIG. 2 is a lateral perspective schematic diagram of a first housing according to Embodiment 1 of the present application;

FIG. 3 is a vertical structural schematic diagram of a second housing according to Embodiment 1 of the present application;

FIG. 4 is a schematic diagram of a combined structure of the first housing and a fan assembly according to Embodiment 1 of the present application;

FIG. 5 is an oblique perspective structural schematic diagram of the first housing according to Embodiment 1 of the present application;

FIG. 6 is an oblique perspective structural schematic diagram of the second housing according to Embodiment 1 of the present application;

FIG. 7 is a schematic diagram of an overall structure of a portable fan according to Embodiment 2 of the present application;

FIG. 8 is an exploded schematic diagram of a first housing and a second housing according to Embodiment 2 of the present application;

FIG. 9 is an overall schematic diagram of a fan motor according to Embodiment 2 of the present application;

FIG. 10 is an exploded schematic diagram of the fan motor and the first housing according to Embodiment 2 of the present application;

FIG. 11 is a rear perspective schematic diagram of a second housing according to Embodiment 2 of the present application;

FIG. 12 is a schematic diagram of a foldable blowing device according to Embodiment 2 of the present application;

FIG. 13 is a schematic diagram of an overall structure of a portable fan according to Embodiment 3 of the present application;

FIG. 14 is an exploded schematic diagram of a first housing and a second housing according to Embodiment 3 of the present application;

FIG. 15 is a schematic diagram of a receiving housing according to Embodiment 3 of the present application;

FIG. 16 is a partial enlarged schematic diagram of a second rotating shaft (A) according to Embodiment 3 of the present application;

FIG. 17 is an exploded structural schematic diagram of a portable fan according to Embodiment 3 of the present application;

FIG. 18 is a schematic diagram of a first connecting buckle according to Embodiment 3 of the present application;

FIG. 19 is a schematic diagram of an overall structure of a portable fan according to Embodiment 4 of the present application;

FIG. 20 is an exploded structural schematic diagram of a portable fan according to Embodiment 4 of the present application;

FIG. 21 is a schematic diagram of a first housing according to Embodiment 4 of the present application;

FIG. 22 is a schematic diagram of a connection structure of a first PCB and a second PCB according to Embodiment 4 of the present application;

FIG. 23 is a schematic diagram of a connection structure of the first PCB, the second PCB, and electronic components according to Embodiment 4 of the present application;

FIG. 24 is a schematic diagram of a connection structure of the first PCB, the second PCB, and some electronic components according to Embodiment 4 of the present application;

FIG. 25 is a schematic diagram of an overall structure of a portable fan according to Embodiment 5 of the present application;

FIG. 26 is an exploded structural schematic diagram of a portable fan according to Embodiment 5 of the present application;

FIG. 27 is a schematic diagram of a flexible connector according to Embodiment 5 of the present application;

FIG. 28 is a schematic diagram of a light-emitting element according to Embodiment 5 of the present application;

FIG. 29 is a schematic diagram of a second housing and a first type of limiting member according to Embodiment 5 of the present application;

FIG. 30 is a schematic diagram of a second type of limiting member according to Embodiment 5 of the present application;

FIG. 31 is a schematic diagram of a second housing and a third type of limiting member according to Embodiment 5 of the present application;

FIG. 32 is a schematic diagram of an overall structure of a portable fan according to Embodiment 6 of the present application;

FIG. 33 is an exploded structural schematic diagram of a portable fan according to Embodiment 6 of the present application;

FIG. 34 is a schematic diagram of a blade base in a rotating state according to Embodiment 6 of the present application;

FIG. 35 is an exploded structural schematic diagram of a blade base according to Embodiment 6 of the present application; and

FIG. 36 is a schematic diagram of a limiting plate according to Embodiment 6 of the present application; and

FIG. 37 is a schematic diagram of an overall structure of a portable fan according to Embodiment 3 of the present application.

### DETAILED DESCRIPTION OF EMBODIMENTS

### Embodiment 1

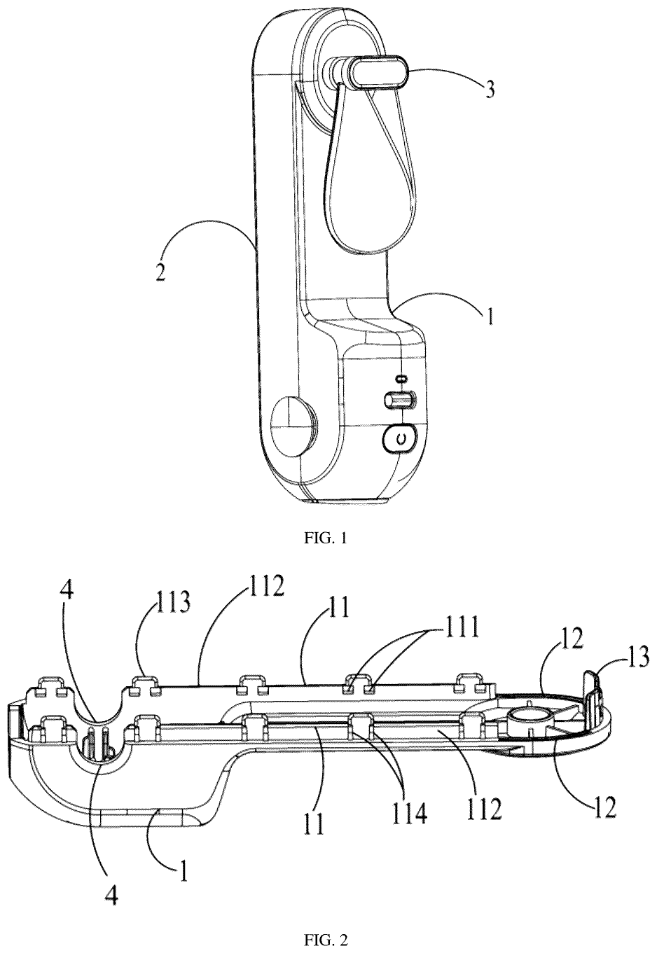

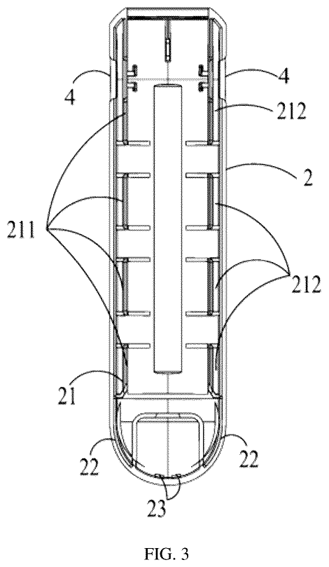

Refer to FIG. 1, FIG. 2, and FIG. 3. FIG. 1 is a schematic diagram of an overall structure of a portable fan according to this embodiment; FIG. 2 is a lateral perspective schematic diagram of a first housing according to this embodiment; and FIG. 3 is a vertical structural schematic diagram of a second housing according to this embodiment.

As shown in FIG. 1, FIG. 2, and FIG. 3, the portable fan includes a first housing 1 and a second housing 2. A fan assembly 3 is arranged on the first housing 1; the second housing 2 is fastened onto the first housing 1; an edge of the first housing 1 protrudes toward the second housing 2 to form an insertion member 11, the insertion member 11 is provided with a plurality of first engaging members 111; a clamping member 21 is arranged in the second housing 2, a first insertion groove 212 is formed between the clamping member 21 and an inner surface of the second housing 2, the clamping member 21 is provided with a plurality of second engaging members 213 mating with the plurality of first engaging members 111; and the insertion member 11 is inserted into the first insertion groove 212, and the plurality of first engaging members 111 are engaged with the plurality of second engaging members 213 in a mating manner.

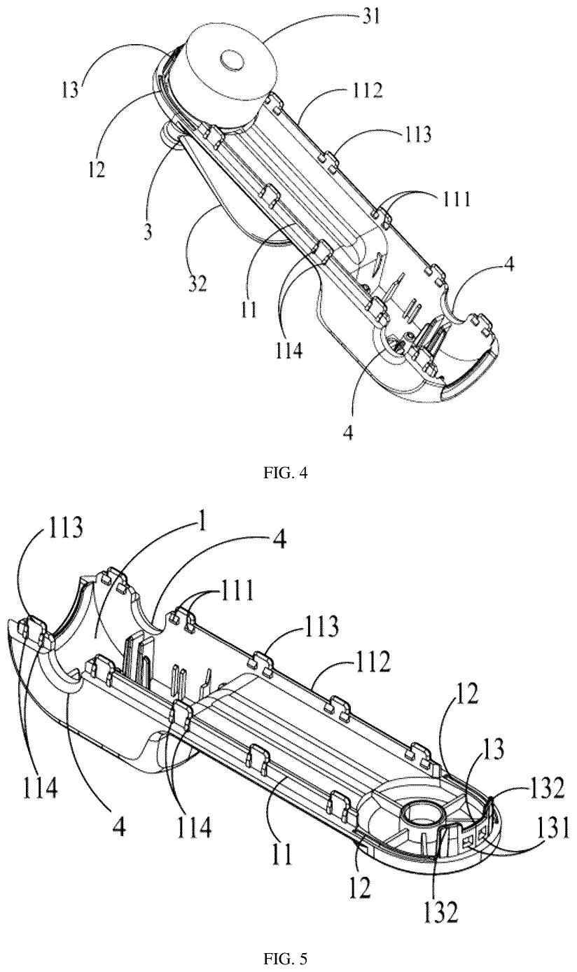

Refer to FIG. 4. FIG. 4 is a schematic diagram of a combined structure of the first housing and the fan assembly according to this embodiment.

As shown in FIG. 4, the fan assembly 3 includes a fan motor 31 and fan blades 32. A shaft hole (not labeled) is formed on the first housing 1; the fan motor 31 is arranged in the first housing 1, and a rotating shaft (not labeled) of the fan motor 31 is inserted through and extends out of the shaft hole; and the fan blades 32 are arranged outside the first housing 1 and connected to an end of the rotating shaft extending out of the shaft hole.

In this embodiment, the first engaging members 111 may be: claws or bayonets. The second engaging members 213 may be: claws or bayonets. Since the first engaging members 111 and the second engaging members 213 need to be engaged with each other, when the first engaging members 111 are claws, the second engaging members 213 may be claws or bayonets. When both the first engaging members 111 and the second engaging members 213 are claws, they are engaged in an interleaved manner. When the first engaging members 111 are claws and the second engaging members 213 are bayonets, the first engaging members 111 are hooked into the second engaging members 213. Similarly, when the second engaging members 213 are claws, the first engaging members 111 may also be claws or bayonets.

It should be noted that when the first engaging members 111 are bayonets, the second engaging members 213 can only be claws. Similarly, when the second engaging members 213 are bayonets, the first engaging members 111 can only be claws.

In the foregoing embodiment, the housing of the portable fan is divided into the first housing 1 and the second housing 2. An insertion member 11 is formed at the edge of the first housing 1, and a plurality of first engaging members 111 are arranged on the insertion member 11. A clamping member 21 is arranged inside the second housing 2, and the clamping member 21 is not arranged on the surface of the second housing 2 but inside the second housing 2. A first insertion groove 212 is formed between the clamping member 21 and the surface of the second housing 2, and a plurality of second engaging members 213 are arranged on the clamping member 21. During assembly, the insertion member 11 is first inserted into the first insertion groove 212, and then the plurality of first engaging members 111 and the plurality of second engaging members 213 on the insertion member 11 and the clamping member 21 are respectively engaged. In the foregoing structure, since the clamping member 21 is arranged inside the second housing 2 and has a gap with the surface of the second housing 2, no abnormal protrusion or warping occurs on the surfaces of the first housing 1 and the second housing 2 during the snap-fitting process, thereby making the surface of the portable fan smoother and more regular. In addition, due to the mating between the insertion groove and the insertion member 11, even when the portable fan is subjected to an external force, the first engaging members 111 and the second engaging members 213 will not disengage from each other, thereby improving the strength and stability of the snap-fit connection of the portable fan.

The insertion member 11 includes a first insertion plate 112 arranged along the length direction of the first housing 1, and the plurality of first engaging members 111 are arranged on the first insertion plate 112.

Specifically, the insertion member 11 includes two first insertion plates 112 arranged oppositely on two sides of the first housing 1 along the length direction. Each first insertion plate 112 is provided with a plurality of first engaging members 111.

By arranging the insertion member 11 as the first insertion plate 112 extending along the length direction of the first housing 1, when the plurality of first engaging members 111 and the second engaging members 213 are squeezed or twisted by an external force, the force applied to the locally stressed first engaging members 111 and second engaging members 213 can be transmitted and shared through the stress of the first insertion plate 112, thereby improving the connection stability.

The insertion member 11 includes a plurality of insertion heads 113 spaced apart on the first insertion plate 112. The insertion heads 113 may be distributed at equal intervals, but the arrangement is not limited thereto. Depending on different application scenarios, in some embodiments, the insertion heads 113 may be arranged at unequal intervals. For example, in some embodiments, the insertion heads 113 are distributed more densely at both ends of the first housing 1 and relatively sparsely in the middle of the first housing 1.

The insertion heads 113 allow the insertion member 11 to be inserted deeper into the first insertion groove 212 locally, thereby making the connection between the insertion member 11 and the first insertion groove 212 tighter and more stable. In addition, the insertion heads 113 also serve as a guide to better guide the first insertion plate 112 into the first insertion groove 212.

Every two of the plurality of first engaging members 111 are arranged as a pair below each of the plurality of insertion heads 113.

The paired first engaging members 111 can form a local linear structure, which can restrict each other and reduce the occurrence of disengagement.

The combination of the plurality of first engaging members 111 is not limited to pairs. In some embodiments, the plurality of first engaging members 111 may be provided singly or in groups of three, four, or more below each insertion head 113.

By arranging the first engaging members 111 below the insertion heads 113, the guiding function of the insertion heads 113 can facilitate the engagement between the first engaging members 111 and the second engaging members 213, thereby simplifying assembly.

The insertion member 11 is further provided with a guide piece 114. The guide piece 114 is arranged on a side of the first insertion plate 112 facing away from the clamping member 21, and the guide piece 114 extends from the edge of the first housing 1 toward a side of the first insertion plate 112 facing the second housing 2 and gradually decreases in size along the extending direction.

The guide piece 114 is arranged on the side of the first insertion plate 112 facing away from the clamping member 21, opposite to the position of the first engaging members 111.

The guide piece 114 can make the connection between the first insertion plate 112 and the first insertion groove 212 tighter, thereby avoiding left-right shaking of the first housing 1 and the second housing 2 caused by gaps between the first insertion plate 112 and the first insertion groove 212. In addition, during the insertion of the first insertion plate 112 into the first insertion groove 212, the guide piece 114 gradually increases, which not only guides the insertion but also gradually increases the support and restraint force on the first engaging members 111. This ensures that the top end of the first insertion plate 112 has sufficient deformation space during insertion to achieve snap-fit engagement, and also ensures that after engagement, the movable space of the first insertion plate 112 is limited, thereby making it easier for the first engaging members 111 to engage with the second engaging members 213.

The clamping member 21 includes a plurality of first clamping plates 211 spaced apart along the length direction of the second housing 2.

The first clamping plates 211 may be distributed at equal intervals, but the arrangement is not limited thereto. Depending on different application scenarios, in some embodiments, the first clamping plates 211 may be arranged at unequal intervals. For example, in some embodiments, the first clamping plates 211 are distributed more densely at both ends of the second housing 2 and relatively sparsely in the middle of the second housing 2.

The first clamping plates 211 are arranged inside the second housing 2 and located inside the two side edges of the second housing 2, with the first clamping plates 211 on the left and right sides arranged in pairs.

The plurality of first clamping plates 211 are independent and spaced apart, which facilitates the separation of the snap-fit connection between the first housing 1 and the second housing 2.

Every two of the plurality of second engaging members 213 are arranged as a pair on each of the plurality of first clamping plates 211.

The paired second engaging members 213 can form a local linear structure, which can restrict each other and reduce the occurrence of disengagement.

The combination of the plurality of second engaging members 213 is not limited to pairs. In some embodiments, the plurality of first engaging members 111 may be provided singly or in groups of three, four, or more on each first clamping plate 211.

Each of the plurality of first clamping plates 211 is provided with connecting plates 214 on both sides. One end of each connecting plate 214 is connected to the first clamping plate 211, and the other end is connected to the inner surface of the second housing 2, with the height of the connecting plates 214 being lower than that of the first clamping plates 211.

The connecting plates 214 arranged on both sides of each first clamping plate 211 can enhance the stability of the first clamping plates 211, thereby making them less likely to bend when subjected to external force, thereby making the snap-fit connection more firm.

In some embodiments, when the insertion member 11 includes the first insertion plate 112, to facilitate the insertion of the continuous first insertion plate 112 into the spaced first insertion grooves 212, the height of the connecting members on both sides of the first clamping plate 211 is lower than that of the first clamping plate 211. This structure can form gaps at the ends of the first clamping plate 211 close to the first housing 1, and the first insertion plate 112 can be inserted through the gaps.

It should be noted that in some embodiments, the first insertion plate 112 may also have the same independent and spaced structure as the first clamping plate 211. In other embodiments, the first clamping plate 211 may also be continuous like the first insertion plate 112, extending continuously along the length direction of the second housing 2.

In some embodiments, since the fan motor 31 in the fan assembly 3 is generally circular and arranged at the end of the first housing 1, where the structure is relatively compact, it is not easy to arrange independent first clamping plates 211 for snap-fit connection. Therefore, the first housing 1 is provided with second insertion grooves 12 on both sides of the fan assembly 3, and the edge of the second housing 2 at positions corresponding to the second insertion grooves 12 protrudes to form second insertion plates 22 mating with the second insertion grooves 12. Both the second insertion grooves 12 and the second insertion plates 22 are curved along the circumferential direction of the fan assembly 3.

By providing the second insertion grooves 12 on both sides of the fan motor 31 in the first housing 1 and the second insertion plates 22 at corresponding positions in the second housing 2, with both the second insertion grooves 12 and the second insertion plates 22 curved along the circumferential direction of the fan assembly 3, the insertion structure can better fit the outer contour of the fan motor 31, thereby making the portable fan more compact. In addition, the insertion structure provided on both sides of the fan motor 31 ensures the sealing performance of the first housing 1 and the second housing 2 around the fan motor 31, thereby avoiding the problem of insufficient tightness at this position due to the lack of a connection structure. This effectively prevents dust and foreign objects from entering the housing through this position, thereby ensuring the cleanliness inside the housing. In addition, since both the second insertion grooves 12 and the second insertion plates 22 are arranged at the edge positions of the first housing 1 and the second housing 2 and therefore are exposed and visible, during assembly, the insertion between the second insertion grooves 12 and the second insertion plates 22 can be used as a positioning structure for assembling the first housing 1 and the second housing 2, improving assembly efficiency and facilitating the alignment and engagement between the first engaging members 111 and the second engaging members 213.

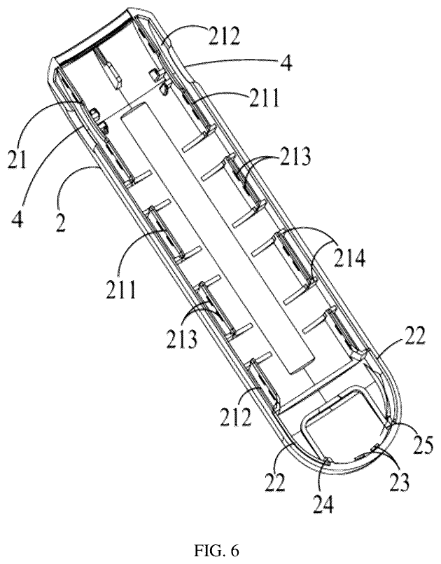

Refer to FIG. 5 and FIG. 6. FIG. 5 is an oblique perspective structural schematic diagram of the first housing according to this embodiment; and FIG. 6 is an oblique perspective structural schematic diagram of the second housing according to this embodiment.

As shown in FIG. 5 and FIG. 6, at the edge of the end of the first housing 1 where the fan assembly 3 is arranged, a second clamping plate 13 protrudes toward the second housing 2. The second clamping plate 13 is provided with third engaging members 131, and the inner surface of the second housing 2 is formed with fourth engaging members 23 mating with the third engaging members 131 at positions corresponding to the third engaging members 131. The second clamping plate 13 is curved along the circumferential direction of the fan assembly 3.

In this embodiment, the third engaging members 131 may be: claws or bayonets. The fourth engaging members 23 may be: claws or bayonets. Since the third engaging members 131 and the fourth engaging members 23 need to be engaged with each other, when the third engaging members 131 are claws, the fourth engaging members 23 may be claws or bayonets. When both the third engaging members 131 and the fourth engaging members 23 are claws, they are engaged in an interleaved manner. When the third engaging members 131 are claws and the fourth engaging members 23 are bayonets, the third engaging members 131 are hooked into the fourth engaging members 23. Similarly, when the fourth engaging members 23 are claws, the third engaging members 131 may also be claws or bayonets.

It should be noted that when the third engaging members 131 are bayonets, the fourth engaging members 23 can only be claws. Similarly, when the fourth engaging members 23 are bayonets, the third engaging members 131 can only be claws.

The second clamping plate 13 is curved along the circumferential direction of the fan assembly 3. This allows the second clamping plate 13 to better fit the outer contour of the fan motor 31, thereby making the portable fan more compact. In addition, the second clamping plate 13 positions the fan motor 31, thereby facilitating the assembly of the fan motor 31.

The second housing 2 is provided with a first limiting plate 24 and a second limiting plate 25 on both sides of the fourth engaging members 23, respectively, and the second clamping plate 13 is arranged between the first limiting plate 24 and the second limiting plate 25.

The first limiting plate 24 and the second limiting plate 25 limit the position of the second clamping plate 13 during assembly, thereby facilitating the assembly of the first housing 1 and the second housing 2, and facilitating the engagement between the third engaging members 131 and the fourth engaging members 23.

Two guide tongues 132 protrude from a side of the second clamping plate 13 facing the first housing 1, with a gap left between the two guide tongues 132. The two guide tongues 132 can extend the length of the second clamping plate 13, thereby making it easier for the second clamping plate 13 to enter the space between the first limiting plate 24 and the second limiting plate 25, thus simplifying assembly. In addition, the gap between the two guide tongues 132 allows the guide tongues 132 to deform toward the middle when squeezed from both sides, thereby avoiding assembly failure caused by mismatched dimensions between the second clamping plate 13 and the space between the first limiting plate 24 and the second limiting plate 25 due to manufacturing errors, and improving tolerance for manufacturing errors.

A cut surface is formed on a side of the first limiting plate 24 and the second limiting plate 25 facing the fan assembly 3, so that the first limiting plate 24 and the second limiting plate 25 are attached to the surface of the fan assembly 3. Since the first limiting plate 24 and the second limiting plate 25 are attached to the fan motor 31, they can stabilize the fan motor 31. The cut surface increases the contact area with the fan motor 31 and can adapt to the annular structure of the fan motor 31, thereby making the portable fan more compact.

In this embodiment, the cut surface is formed by cutting two adjacent side surfaces of the first limiting plate 24 or the second limiting plate 25 that face the fan motor 31.

In some embodiments, the portable fan is a foldable fan. In this application scenario, the first housing 1 and the second housing 2 are provided with shaft holes 4. Therefore, the first insertion plate 112 is disconnected at the position of the shaft holes, and a set of first engaging members 111 and one insertion head 113 are provided on both the left side and right side of the disconnected position. The first clamping plate 211 corresponding to the position of the shaft holes is provided with an arc-shaped notch, and the first clamping plate 211 is divided into two parts by the arc-shaped notch, with a set of second engaging members 213 provided on both the left side and right side of the arc-shaped notch.

### Embodiment 2

In hot summers, fans have become essential appliances for users to relieve heat. With the increasing demand for convenient use, fans that are lighter and more portable have gained growing popularity.

In the prior art, electrically driven fans are all provided with a fan motor inside. To fix the fan motor, a special clamping structure or screws are generally arranged in the fan housing to fix the fan motor. The applicant of the present application has found in research that the fixing method of the fan motor in the prior art has a complex structure and affects the volume of the fan.

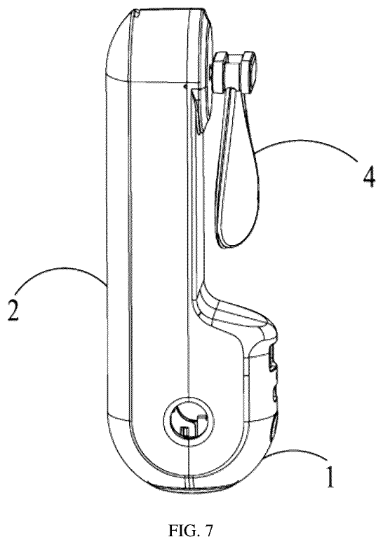

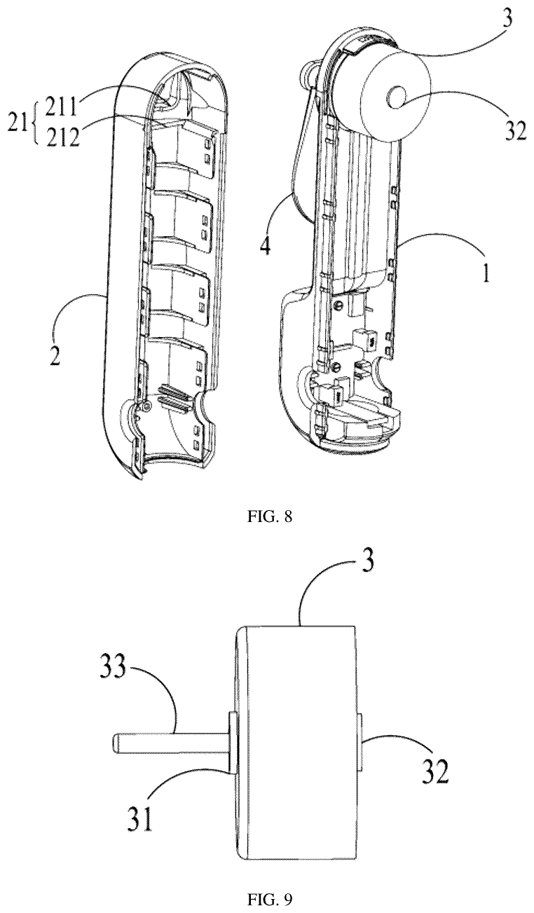

Refer to FIG. 7 and FIG. 8. FIG. 7 is a schematic diagram of an overall structure of a portable fan according to this embodiment; and FIG. 8 is an exploded schematic diagram of a first housing and a second housing according to this embodiment.

As shown in FIG. 7 and FIG. 8, the portable fan includes a first housing 1, a fan motor 3, fan blades 4, and a second housing 2. A shaft hole 12 is formed on the first housing 1; the fan motor 3 is arranged in the first housing 1, and a rotating shaft 33 of the fan motor 3 is inserted through and extends out of the shaft hole 12; the fan blades 4 are arranged outside the first housing 1 and connected to an end of the rotating shaft 33 extending out of the shaft hole 12; and the second housing 2 is connected to the first housing 1, and a fixing bracket 21 is arranged on the second housing 2, and the fixing bracket 21 abuts against the fan motor 3, so that the first housing 1 and the second housing 2 clamp and fix the fan motor 3.

In the foregoing embodiment, the portable fan includes the first housing 1 and the second housing 2, the fan motor 3 is arranged in the first housing 1, the first housing 1 and the second housing 2 are connected to each other, the second housing 2 is provided with the fixing bracket 21, and the fixing bracket 21 can abut against the fan motor 3 when the first housing 1 and the second housing 2 are connected to each other, so that the first housing 1 and the fixing bracket 21 generate a clamping force on the fan motor 3, thereby fixing the fan motor 3. The fixing method of clamping the fan motor 3 by the first housing 1 and the second housing 2 results in a simple structure, makes the internal structure of the fan more compact, and makes the volume of the portable fan smaller.

The first housing 1 and the second housing 2 are connected through clamping. However, the connection mode between the first housing 1 and the second housing 2 is not limited thereto. Depending on different specific application scenarios, in some embodiments, the first housing 1 and the second housing 2 can also be connected through (but not limited to) gluing, hot melting, screws, or riveting.

In this embodiment, the main body of the fan motor 3 is arranged in a cylindrical shape, the fan motor 3 is provided with the rotating shaft 33, where one end of the rotating shaft 33 is arranged inside the fan motor 3, and the other end extends out of the fan motor 3.

In this embodiment, the fan blades 4 are double-bladed axial flow fans, and the fan blades 4 are foldable blades. However, the quantity of blades of the fan blades 4 is not limited thereto. Depending on different specific application scenarios, in some embodiments, the quantity of blades of the fan blades 4 can be 3, 4, 5, or more. In some embodiments, the blades of the fan blades 4 can be fixed blades. In some embodiments, the fan blades can also be (but not limited to) side-flow fans, diagonal-flow fans, or centrifugal fans.

Refer to FIG. 9. FIG. 9 is an overall schematic diagram of the fan motor of this embodiment.

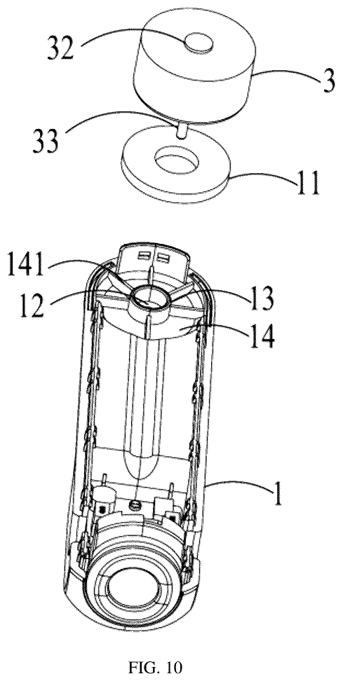

As shown in FIG. 9 and FIG. 10, an end of the fan motor 3 facing the first housing 1 protrudes to form a first boss 31, the rotating shaft 33 passes through the first boss 31, an inner surface of the first housing 1 facing the fan motor 3 forms a receiving ring 13 mating with the first boss 31, the receiving ring 13 is communicated with the shaft hole 12, and the first boss 31 extends into the receiving ring 13.

The first boss 31 in this embodiment is a circular boss. However, the shape of the boss is not limited thereto. Depending on different specific application scenarios, in some embodiments, the shape of the first boss 31 can be (but not limited to) elliptical, prismatic, racetrack-shaped, or the like.

The receiving ring 13 and the shaft hole 12 are stacked on each other and communicated with each other to form a tower shape.

The first boss 31 extends into the receiving ring 13, which can prevent the first boss 31 from directly contacting the inner surface of the first housing 1, reduce the possibility of damage caused by extrusion contact, and can well protect the fan motor 3 from damage.

Refer to FIG. 10. FIG. 10 is an exploded schematic diagram of the fan motor and the first housing according to this embodiment.

As shown in FIG. 10, a flexible connecting ring 11 is arranged between the fan motor 3 and the inner surface of the first housing 1, where one end of the flexible connecting ring 11 is adhesively connected to the first housing 1, and the other end of the flexible connecting ring 11 is adhesively connected to the fan motor 3.

The flexible connecting ring 11 is sleeved on the outer side of the receiving ring 13, and both sides of the flexible connecting ring 11 are coated with glue, so that both sides of the flexible connecting ring 11 can be respectively adhesively connected to the first housing 1 and the fan motor 3. The arrangement of the flexible connecting ring 11 can further enhance the connection stability of the fan motor 3, thereby making the fan motor 3 more stably fixed. In addition, the flexible connecting ring 11 can play a buffering role, which can avoid damage caused by rigid contact between the fan motor 3 and the first housing 1. In addition, the flexible connecting ring 11 can also make the assembly space of the fan motor 3 in an adjustable state. When the size of the fan motor 3 has variable errors, the deformation space of the flexible connecting ring 11 can increase the tolerance for the size of the fan motor 3 and improve the adaptability. In addition, the buffering effect can also reduce the noise generated when the fan motor 3 works.

In some embodiments, when the first housing 1 is not provided with the receiving ring 13 for receiving the first boss 31, the center of the flexible connecting ring 11 can be further reduced to be the same as the area of the shaft hole 12.

In some embodiments, a side of the flexible connecting ring 11 connected to the fan motor 3 is flush with or higher than the surface of the receiving ring 13. Such a structure of the flexible connecting ring 11 and the receiving ring 13 can effectively avoid damage caused by rigid contact between the receiving ring 13 and the fan motor 3.

In this embodiment, the flexible connecting ring 11 is made of foam glue. However, the material of the flexible connecting ring 11 is not limited thereto. Depending on different specific application scenarios, in some embodiments, the flexible connecting ring 11 can be an annular body made of (but not limited to) a silicone ring coated with glue, a fabric ring made of fabric, a paper ring, or other elastic materials.

An inner surface of the first housing 1 is recessed at a position corresponding to the flexible connecting ring 11 to form a receiving cavity 14, and the flexible connecting ring 11 is adhesively connected to the receiving cavity 14. The arrangement of the receiving cavity 14 can make the thickness of the flexible connecting ring 11 thicker, and can improve the buffering performance of the flexible connection. In addition, the arrangement of the receiving cavity 14 can also increase the contact area between the flexible connecting ring 11 and the first housing 1, generate greater friction, and better offset the lateral torque generated when the fan motor 3 rotates.

A plurality of reinforcing ribs 141 are arranged in the receiving cavity 14, the plurality of reinforcing ribs 141 are arranged radially around the receiving ring 13, and the flexible connecting ring 11 is adhesively connected to one side surface of the plurality of reinforcing ribs 141.

In this embodiment, the quantity of the reinforcing ribs 141 is 6. However, the quantity of the reinforcing ribs 141 is not limited thereto. Depending on different specific application scenarios, in some embodiments, the quantity of the reinforcing ribs 141 can be (but not limited to) 2, 3, 4, 5, 7, or more.

The arrangement of the reinforcing ribs 141 can enhance the connection strength between the receiving ring 13 and the first housing 1. The space between the reinforcing ribs 141 can provide a larger deformation space for the flexible connecting ring 11, improving the local buffering effect of the flexible connecting ring 11. In addition, the arrangement of the reinforcing ribs 141 can form a hollow area between the flexible connecting ring 11 and the first housing 1, and the hollow area can absorb noise and reduce the vibration noise generated when the fan motor 3 works.

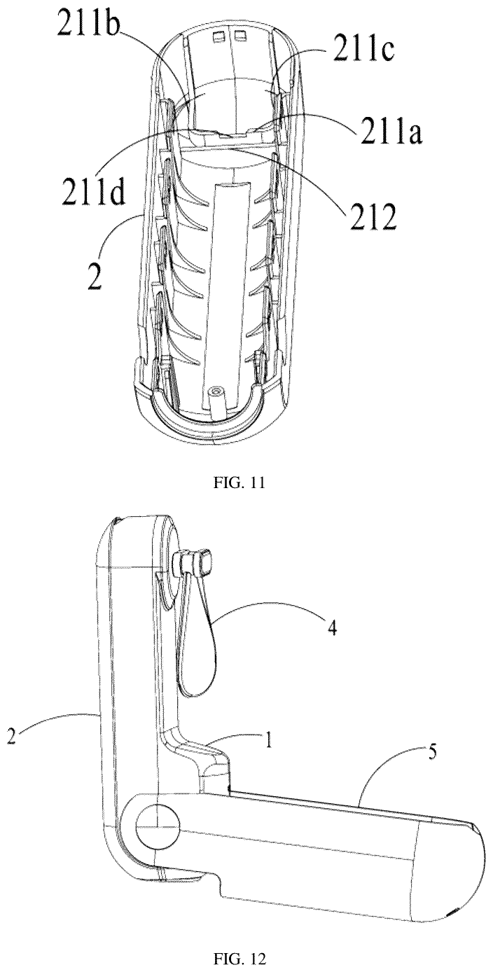

Refer to FIG. 11. FIG. 11 is a rear perspective schematic diagram of the second housing 2 according to this embodiment.

The fixing bracket 21 includes a first abutting member 211. One end of the first abutting member 211 is connected to the inner surface of the second housing 2, and the other end of the first abutting member 211 abuts against a side surface of the fan motor 3 facing the second housing 2.

A second boss 32 protrudes from a side surface of the fan motor 3 facing the second housing 2, the first abutting member 211 spans across the second boss 32, and a notch 211d is formed at a position corresponding to the second boss 32. The position of the second boss 32 of the fan motor 3 is generally a position facing a rotor (not shown) of the fan motor 3, and the arrangement of the notch 211d avoids extrusion of the fan motor 3 by the first abutting member 211, playing a protective role for the fan motor 3.

The first abutting member 211 includes a first abutting piece 211a, a second abutting piece 211b, and a third abutting piece 211c. The first abutting piece 211a spans across the second boss 32, the notch 211d is formed on the first abutting piece 211a, the second abutting piece 211b and the third abutting piece 211c are respectively connected to one end of the first abutting piece 211a, and the second abutting piece 211b and the third abutting piece 211c are parallel to each other and gradually decrease in thickness along with the curvature of the inner surface of the second housing 2. The arrangement of the first abutting piece 211a, the second abutting piece 211b, and the third abutting piece 211c can increase the contact area with the fan motor 3, make the extrusion force received by the fan motor 3 more uniform, and also increase the abutting area. The change in thickness of the second abutting piece 211b and the third abutting piece 211c can keep the contact surfaces of the second abutting piece 211b and the third abutting piece 211c with the fan motor 3 horizontal, and also can make the fan motor 3 stressed uniformly.

The fixing bracket 21 further includes a second abutting member 212. One end of the second abutting member 212 is connected to the inner surface of the second housing 2, the other end of the second abutting member 212 abuts against a side surface of the fan motor 3 facing the second housing 2, and there is a gap between the first abutting member 211 and the second abutting member 212. The arrangement of the second abutting member 212 can further increase the area of the fan motor 3 subjected to extrusion force, thereby making the fan motor 3 more stable. In addition, since the second abutting member 212 is spaced apart from the first abutting member 211, it can avoid the problem of unbalanced stress caused by the fan motor 3 being subjected to force on one side or the stress points being too concentrated in some areas, further improving the stability and balance of the fan motor 3.

### Embodiment 3

In hot summers, fans have become essential appliances for users to relieve heat. With the increasing demand for convenient use, fans that are lighter and more portable have gained growing popularity.

Foldable fans are favored by users due to their small size and ease of carrying. In the prior art, a foldable fan includes a receiving housing having a receiving cavity and a fan main body having a fan assembly, with the fan main body and the receiving housing movably connected. When the foldable fan is in use, to ensure the stability of the air outlet direction of the foldable fan, it is necessary to maintain the spatial form between the fan main body and the receiving housing in a specific state.

The applicant of the present application has found in research that in the foldable fan in the prior art, the relative form between the fan main body and the receiving housing is maintained by the friction force between the contact surfaces of the fan main body and the receiving housing. As the fan is used, the friction force between the contact surfaces of the fan main body and the receiving housing will gradually decrease, resulting in the inability to maintain the stable form between the fan main body and the receiving housing, which affects the use of the foldable fan.

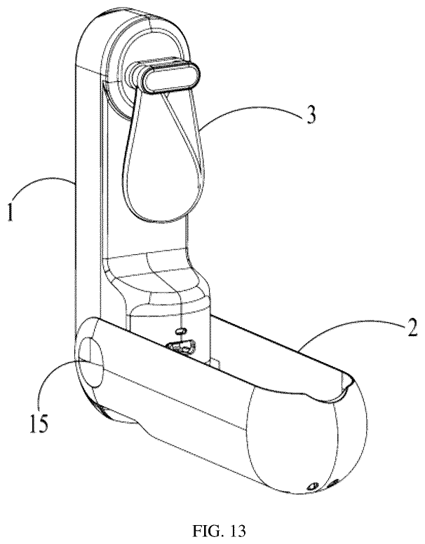

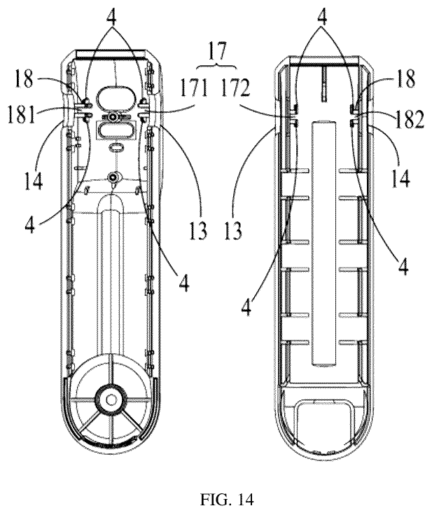

Refer to FIG. 13 and FIG. 14. FIG. 13 is a schematic diagram of an overall structure of a portable fan according to this embodiment; and FIG. 14 is a perspective structural schematic diagram of a first housing and a second housing according to this embodiment.

As shown in FIG. 13, the portable fan includes a fan main body 1 and a receiving housing 2.

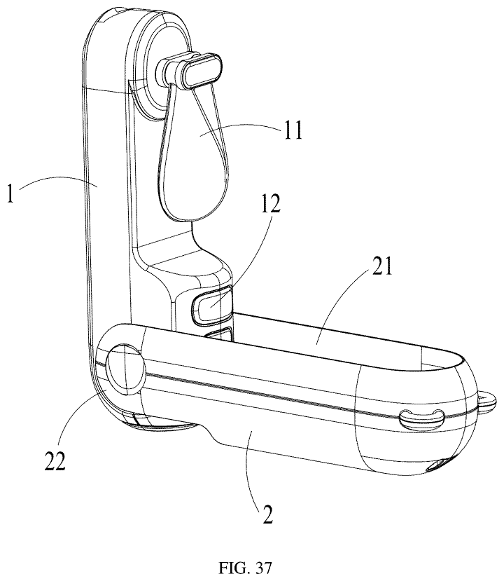

As shown in FIG. 37, the portable fan includes: a fan main body 1 provided with a fan blade 11; a receiving housing 2 defining a storage cavity 21 configured to receive the fan main body 1, wherein one end of the receiving housing 2 is provided with two connecting ears 22 oppositely arranged, the two connecting ears 22 being rotatably connected to the fan main body 1, respectively; and an electronic display screen 12 disposed on a surface of the fan main body 1 facing the receiving housing 2, wherein the electronic display screen 12 is configured to display a gear level of a rotation speed of the fan blade.

One end of the fan main body 1 is provided with two opposite first rotating shaft holes 13 and second rotating shaft holes 14. The receiving housing 2 is provided with a first rotating shaft 21 and a second rotating shaft 22 mating with the first rotating shaft holes 13 and the second rotating shaft holes 14. The receiving housing 2 is provided with a receiving cavity (not shown) for storing the fan main body 1, a first limiting member 17 and a second limiting member 18 are respectively arranged in the fan main body 1, the first limiting member 17 abuts against the first rotating shaft 21, and the second limiting member 18 abuts against the second rotating shaft 22 to maintain the relative spatial form between the fan main body 1 and the receiving housing 2.

A fan assembly 3 is arranged on the fan main body 1. The fan main body 1 includes a first housing 11 and a second housing 12. The fan assembly 3 includes a fan motor 31 and fan blades 32. A motor shaft hole 34 is formed on the first housing 11; the fan motor 31 is arranged in the first housing 11, and a motor rotating shaft 33 of the fan motor 31 is inserted through and extends out of the motor shaft hole 34; and the fan blades 32 are arranged outside the first housing 11 and connected to an end of the motor rotating shaft 33 extending out of the motor shaft hole 34.

In some embodiments, the fan main body 1 can also be formed as a complete housing through an integral molding process.

One end of the fan main body 1 connected to the receiving housing 2 is provided with a first rotating shaft hole 13 and a second rotating shaft hole 14, both of which are formed at the joint of the first housing 11 and the second housing 12. However, the positions of the first rotating shaft hole 13 and the second rotating shaft hole 14 are not limited thereto. Depending on different specific application scenarios, in some embodiments, the first rotating shaft hole 13 and the second rotating shaft hole 14 can be formed on the first housing 11 or the second housing 12. When the fan main body 1 is an integrally formed structure, the first rotating shaft hole 13 and the second rotating shaft hole 14 are formed at any position of one end of the fan main body 1.

A receiving cavity is formed on the receiving housing 2, and two lugs (not labeled) extend from one end of the receiving housing 2 connected to the fan main body 1. The two lugs are respectively provided with a first rotating shaft 21 and a second rotating shaft 22 mating with the first rotating shaft hole 13 and the second rotating shaft hole 14.

In some embodiments, the first rotating shaft 21 and the second rotating shaft 22 are arranged inside the receiving cavity.

The first rotating shaft 21 is inserted into the first rotating shaft hole 13, and the second rotating shaft 22 is inserted into the second rotating shaft hole 14. Through the synchronous linked rotation of the first rotating shaft 21 and the second rotating shaft 22 in the first rotating shaft hole 13 and the second rotating shaft hole 14, respectively, the rotational connection between the fan main body 1 and the receiving housing 2 is realized, so that the fan main body 1 can be stored in the receiving cavity of the fan housing and can be exposed outside the receiving housing 2 by rotation.

The first limiting member 17 and the second limiting member 18 abut against the first rotating shaft 21 and the second rotating shaft 22, respectively. The abutting relationship between the first limiting member 17 and the second limiting member 18 and the first rotating shaft 21 and the second rotating shaft 22 can be continuous or intermittent. When the first limiting member 17 and the second limiting member 18 continuously abut against the first rotating shaft 21 and the second rotating shaft 22, the first limiting member 17 and the second limiting member 18 can maintain the relative spatial form between the fan main body 1 and the receiving housing 2 at any angle. When the first limiting member 17 and the second limiting member 18 intermittently abut against the first rotating shaft 21 and the second rotating shaft 22, as the positions of the fan main body 1 and the receiving housing 2 change, the first limiting member 17 and the second limiting member 18 intermittently disengage from the first rotating shaft 21 and the second rotating shaft 22, and at this time, the first limiting member 17 and the second limiting member 18 do not have the function of maintaining the relative spatial form between the fan main body 1 and the receiving housing 2. As the positions of the fan main body 1 and the receiving housing 2 change, the first limiting member 17 and the second limiting member 18 intermittently abut against the first rotating shaft 21 and the second rotating shaft 22 again, and at this time, the first limiting member 17 and the second limiting member 18 have the function of maintaining the relative spatial form between the fan main body 1 and the receiving housing 2.

In the foregoing embodiment, two opposite shaft holes are formed on the fan main body 1, and two rotating shafts mating with the shaft holes are arranged on the receiving housing 2. When the two rotating shafts mate with the two shaft holes, the fan main body 1 and the receiving housing 2 can rotate relative to each other. Two limiting members are arranged in the fan main body 1, and the two limiting members abut against the first rotating shaft 21 and the second rotating shaft 22, respectively. The arrangement of the two limiting members increases the interaction force between the fan main body 1 and the receiving housing 2 through the internal structure of the fan main body 1, so that the relative spatial form between the fan main body 1 and the receiving housing 2 is maintained more stably and is not easily changed by external force, which facilitates the use of the portable fan.

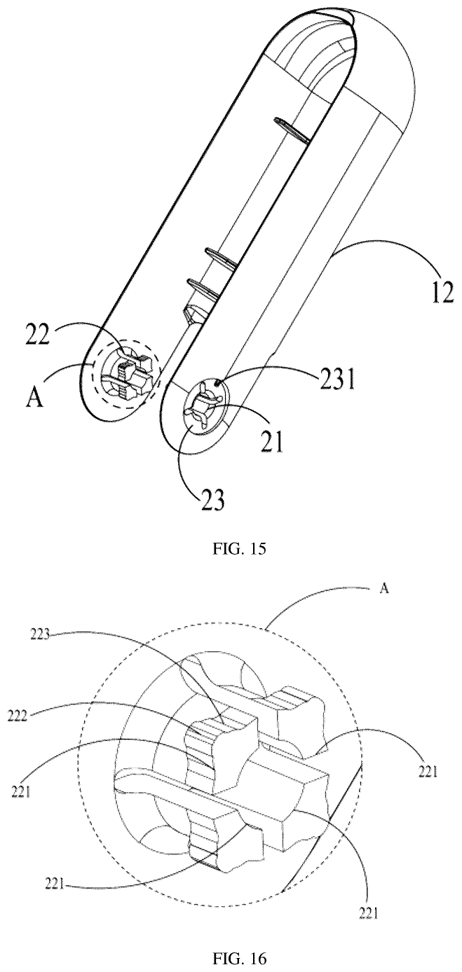

Refer to FIG. 15. FIG. 15 is a schematic diagram of the structure of the receiving housing according to this embodiment.

As shown in FIG. 15, both the first rotating shaft 21 and the second rotating shaft 22 include a plurality of connecting plates 221 spaced apart around the circumference to form an annular rotating shaft. The first limiting member 17 abuts against at least one connecting plate 221 of the first rotating shaft 21, and the second limiting member 18 abuts against at least one connecting plate 221 of the second rotating shaft 22.

The quantity of connecting plates 221 constituting the first rotating shaft 21 is 4. However, the quantity of connecting plates 221 of the first rotating shaft 21 is not limited thereto. Depending on different specific application scenarios, in some embodiments, the quantity of connecting plates 221 constituting the first rotating shaft 21 can be (but not limited to) 2, 3, 5, or more.

The quantity of connecting plates 221 constituting the second rotating shaft 22 is 4. However, the quantity of connecting plates 221 of the second rotating shaft 22 is not limited thereto. Depending on different specific application scenarios, in some embodiments, the quantity of connecting plates 221 constituting the second rotating shaft 22 can be (but not limited to) 2, 3, 5, or more.

The plurality of connecting plates 221 of the first rotating shaft 21 enclose to form a hollow annular rotating shaft. Since there are gaps between the plurality of connecting plates 221, when any one or more of the plurality of connecting plates 221 are squeezed, the connecting plates 221 can deform toward the inside of the annular rotating shaft.

The plurality of connecting plates 221 of the second rotating shaft 22 enclose to form a hollow annular rotating shaft. Since there are gaps between the plurality of connecting plates 221, when any one or more of the plurality of connecting plates 221 are squeezed, the connecting plates 221 can deform toward the inside of the annular rotating shaft.

The plurality of connecting plates 221 constituting the first rotating shaft 21 and the second rotating shaft 22 are all spaced apart, so the abutment with the first limiting member 17 and the second limiting member 18 occurs intermittently. The intermittent abutment between the first rotating shaft 21 and the second rotating shaft 22 and the first limiting member 17 and the second limiting member 18 can make the fan main body 1 and the receiving housing 2 have higher stability at specific spatial positions compared with other spatial positions. This reduces the friction loss between the first rotating shaft 21 and the second rotating shaft 22 and the first limiting member 17 and the second limiting member 18, and improves the hierarchical change of damping when the user rotates the portable fan, thereby providing use convenience for the user. In addition, the spaced connecting plates 221 can make the fan main body 1 and the receiving housing 2 have stronger stability at specific positions, and this stability can be perceived by the user based on the change in resistance, so that the user can easily rotate the portable fan to a predetermined and suitable use position.

Refer to FIG. 16. FIG. 16 is a partial enlarged schematic diagram of the second rotating shaft (A) according to this embodiment.

As shown in FIG. 16, an arc-shaped protrusion 222 protrudes from the outer surface of each of the plurality of connecting plates 221 of the first rotating shaft 21 and the second rotating shaft 22. The first limiting member 17 abuts against at least one arc-shaped protrusion 222 of the first rotating shaft 21, and the second limiting member 18 abuts against at least one arc-shaped protrusion 222 of the second rotating shaft 22.

The arc-shaped protrusions 222 can make the rotation between the fan main body 1 and the receiving housing 2 smoother and reduce the friction between the arc-shaped protrusions 222 and the first limiting member 17 and the second limiting member 18 during rotation.

An arc-shaped boss 223 protrudes from the outer surface of each of the plurality of connecting plates 221, the arc-shaped protrusion 222 is arranged on the arc-shaped boss 223, and the arc-shaped boss 223 and the arc-shaped protrusion 222 form a stepped structure.

The stacked stepped structure of the arc-shaped boss 223 and the arc-shaped protrusion 222 can make the transition smoother when the portable fan rotates. When the first rotating shaft 21 and the second rotating shaft 22 rotate with the rotation of the portable fan, the first limiting member 17 and the second limiting member 18 first abut against the surface of the arc-shaped boss 223 on the connecting plate 221, and then smoothly transition along the surface of the arc-shaped boss 223 to contact with the surface of the arc-shaped protrusion 222. In this process, since both the arc-shaped boss 223 and the arc-shaped protrusion 222 are arc-shaped surfaces, the transition during rotation is smoother. In addition, the arc-shaped boss 223 raises the height of the arc-shaped protrusion 222, thereby making the contact between the arc-shaped protrusion 222 and the first limiting member 17 and the second limiting member 18 more stable.

Each of the plurality of connecting plates 221 is arranged in an arc shape. The first rotating shaft 21 and the second rotating shaft 22 formed by the arc-shaped connecting plates 221 are smoother, thereby avoiding the sense of hysteresis during the rotation of the foldable fan and making the rotation of the foldable fan smoother. However, the shape of the connecting plates 221 is not limited thereto. Depending on different specific application scenarios, in some embodiments, the shape of the connecting plates 221 can be (but not limited to) triangular, rectangular, cylindrical, semi-cylindrical, or the like.

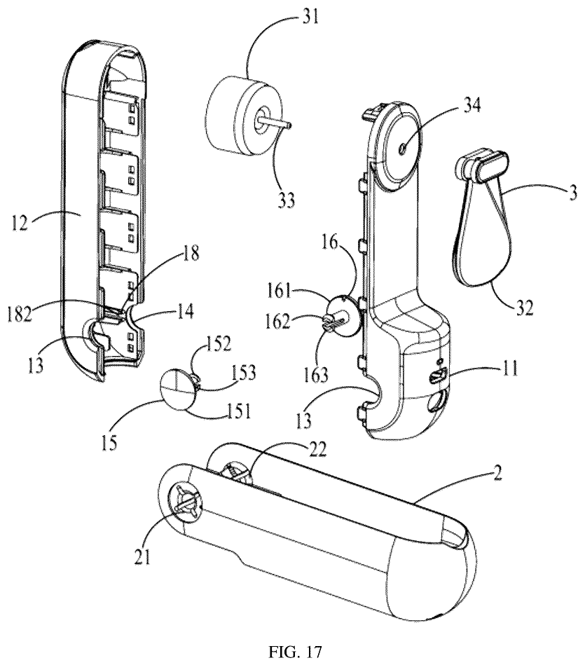

Refer to FIG. 17. FIG. 17 is an exploded structural schematic diagram of the portable fan according to this embodiment.

As shown in FIG. 17, the portable fan further includes a first connecting buckle 15 and a second connecting buckle 16. One end of the first connecting buckle 15 is inserted between the plurality of connecting plates 221 of the first rotating shaft 21, and the other end of the first connecting buckle 15 is located on the outer surface of the receiving housing 2. One end of the second connecting buckle 16 is inserted between the plurality of connecting plates 221 of the second rotating shaft 22, and the other end of the second connecting buckle 16 is located on the outer surface of the receiving housing 2.

During the rotation of the foldable fan, the connecting plates 221 will bend toward the inside of the annular rotating shaft after being squeezed by the first limiting member 17 and the second limiting member 18. During this bending deformation process, if the deformation is excessive, the connecting plates 221 may be damaged, resulting in loss of resilience and difficulty returning to their original state and position. This further reduces the ability to maintain the relative spatial form between the fan main body 1 and the receiving housing 2. The insertion of the first connecting buckle 15 and the second connecting buckle 16 between the connecting plates 221 can prevent excessive deformation of the connecting plates 221 of the first rotating shaft 21 and the second rotating shaft 22.

Both the first connecting buckle 15 and the second connecting buckle 16 include: buckle caps 151, 161; first elastic strips 152, 162; and second elastic strips 153, 163. The first elastic strips 152, 162 and the second elastic strips 153, 163 are all connected to one side of the buckle caps 151, 161, and a gap is provided between the first elastic strips 152, 162 and the second elastic strips 153, 163.

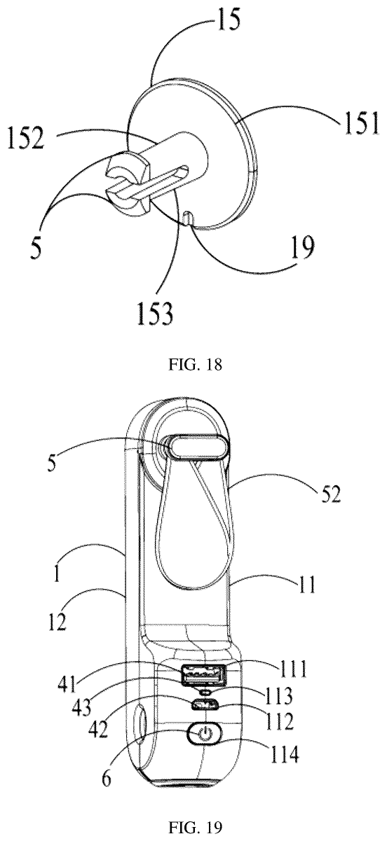

Refer to FIG. 18. FIG. 18 is a structural schematic diagram of the first connecting buckle according to this embodiment.

As shown in FIG. 18, in this embodiment, the buckle caps 151, 161 are arranged in an arc shape. However, the shape of the buckle caps 151, 161 is not limited thereto. Depending on specific application scenarios, in some embodiments, the shape of the buckle caps 151, 161 may be (but not limited to) cylindrical, prismatic, racetrack-shaped, or irregular.

The provision of the buckle caps 151, 161 can prevent external dust or debris from entering the fan main body 1 through the annular rotating shaft, thereby effectively protecting the internal structure of the fan main body 1 from damage and contamination.

The arrangement of the first elastic strips 152, 162 and the second elastic strips 153, 163 enables them to deform when squeezed. During the rotation of the foldable fan, after being squeezed by the first limiting member 17 and the second limiting member 18, the connecting plates 221 bend toward the inside of the annular rotating shaft. During this bending deformation, the connecting plates 221 come into contact with the first elastic strips 152, 162 or the second elastic strips 153, 163 and push them to deform. During the recovery process, the first elastic strips 152, 162 or the second elastic strips 153, 163 provide a restoring force to the connecting plates 221, thereby enabling the connecting plates 221 to better return to their original positions. This reduces the risk that the connecting plates 221 cannot recover due to bending fatigue caused by long-term repeated bending, thereby extending the rotational life of the foldable fan.

The free ends of the first elastic strips 152, 162 and the second elastic strips 153, 163 are each provided with a latch 5. The provision of the latches 5 can prevent the first connecting buckle 15 and the second connecting buckle 16 from falling off, thereby enhancing the stability between the first connecting buckle 15, the second connecting buckle 16, and the first rotating shaft 21 and the second rotating shaft 22.

A positioning groove 19 is formed on the surface of the buckle caps 151, 161 facing the receiving housing 2. A buckle groove 23 is recessed on the surface of the receiving housing 2 facing the buckle caps 151, 161, and a positioning protrusion 231 corresponding to the positioning groove 19 is arranged in the buckle groove 23. The arrangement of the buckle groove 23 can make the connection between the buckle caps 151, 161 and the surface of the receiving housing 2 smoother, reduce the gap between the buckle caps 151, 161 and the receiving housing 2, and improve the dustproof effect. The provision of the positioning groove 19 and the positioning protrusion 231 can simplify the assembly of the buckle caps 151, 161 and also prevent the buckle caps 151, 161 from being rotated by external forces, which may cause friction between the buckle caps 151, 161 and the surface of the receiving housing 2 and result in damage.

Both the first limiting member 17 and the second limiting member 18 include: first clamping grooves 171, 181 and second clamping grooves 172, 182. The first clamping groove 171 and the second clamping groove 172 of the first limiting member 17 are oppositely distributed on both sides of the first rotating shaft 21 and respectively abut against the first rotating shaft 21. The first clamping groove 181 and the second clamping groove 182 of the second limiting member 18 are oppositely distributed on both sides of the second rotating shaft 22 and respectively abut against the second rotating shaft 22.

The first clamping grooves 171, 181 and the second clamping grooves 172, 182 may be arranged along the length direction or the thickness direction of the fan main body 1. However, the arrangement direction of the first clamping grooves 171, 181 and the second clamping grooves 172, 182 is not limited thereto. In some embodiments, the first clamping grooves 171, 181 and the second clamping grooves 172, 182 may be arranged around the first rotating shaft 21 and the second rotating shaft 22 at any angle within a 360° circumferential range.

The first clamping grooves 171, 181 and the second clamping grooves 172, 182 may be formed on the inner surface of the fan main body 1 or protrude from the inner surface of the fan main body 1. The first clamping grooves 171, 181 and the second clamping grooves 172, 182 may also be arranged on internal components of the fan main body 1. For example, when the fan main body 1 includes a first housing 11 and a second housing 12, the second housing 12 is provided with a clamping structure for snap-fit connection, and the first clamping grooves 171, 181 or the second clamping grooves 172, 182 are arranged on the clamping structure.

The provision of the first clamping grooves 171, 181 and the second clamping grooves 172, 182 can increase the contact area between the first limiting member 17, the second limiting member 18 and the first rotating shaft 21, the second rotating shaft 22, and enhance the abutting force, thereby making the relative spatial form between the fan main body 1 and the receiving housing 2 more stable during abutment. In addition, the groove-shaped structure can generate a local clamping force on the first rotating shaft 21 and the second rotating shaft 22 when abutting against them, further improving the stability of the relative spatial form between the fan main body 1 and the receiving housing 2 during abutment.

When the first clamping grooves 171, 181 and the second clamping grooves 172, 182 are used to mate with the arc-shaped protrusions 222, part of the arc-shaped protrusions 222 can be inserted into the grooves, thereby further stabilizing the relative spatial form between the fan main body 1 and the receiving housing 2.

Each of the first clamping grooves 171, 181 and the second clamping grooves 172, 182 includes a first limiting strip (not labeled) and a second limiting strip (not labeled) arranged inside the fan main body 1. The first limiting strip and the second limiting strip are parallel to each other. However, the structure of the first clamping grooves 171, 181 and the second clamping grooves 172, 182 is not limited thereto. In some embodiments, the first clamping grooves 171, 181 and the second clamping grooves 172, 182 may be (but are not limited to) U-shaped grooves, C-shaped grooves, wedge-shaped grooves, or the like.

Each of the first clamping grooves 171, 181 and the second clamping grooves 172, 182 includes a first limiting strip and a second limiting strip arranged inside the fan main body. A reinforcing plate 4 is arranged on the opposite sides of the first limiting strip and the second limiting strip. The reinforcing plate 4 is connected to the inner surface of the fan main body, and the height of the reinforcing plate 4 is less than the height of the first limiting strip and the second limiting strip. The provision of the reinforcing plate 4 can enhance the physical strength of the first limiting strip and the second limiting strip, strengthen the clamping force of the first clamping grooves 171, 181 and the second clamping grooves 172, 182, and improve the stability of the form of the portable fan. In addition, since the height of the reinforcing plate 4 is less than the height of the first limiting strip and the second limiting strip, the positions where the first clamping grooves 171, 181 and the second clamping grooves 172, 182 abut against the first rotating shaft 21 or the second rotating shaft 22 are not reinforced. This can avoid serious frictional damage caused by excessively high physical strength at the abutting positions of the first clamping grooves 171, 181 and the second clamping grooves 172, 182, thereby improving the service life.

### Embodiment 4

In hot summers, fans have become essential appliances for users to relieve heat. With the increasing demand for convenient use, fans that are lighter and more portable have gained growing popularity.

Portable fans are favored by users due to their small size and ease of carrying. The applicant of the present application has found in research that existing portable fans, due to their diverse electrical functions, often require a large quantity of electronic components to achieve these functions. A large quantity of electronic components need to be arranged on a circuit board with a large area, or arranged densely. However, an excessively large circuit board will affect the overall volume of the portable fan, and an excessively dense arrangement of electronic components will intensify electronic interference between the components and cause serious heating problems.

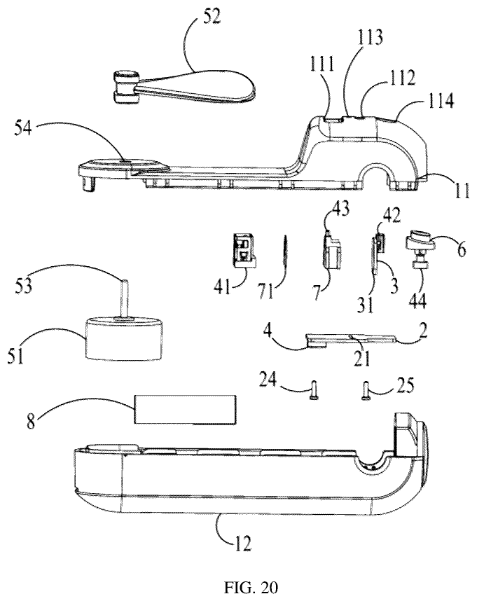

Refer to FIG. 19 and FIG. 20. FIG. 19 is a schematic diagram of an overall structure of a portable fan according to this embodiment; and FIG. 20 is an exploded structural schematic diagram of the portable fan according to this embodiment.

As shown in FIG. 19 and FIG. 20, the portable fan includes a fan main body 1, a first PCB 2, a second PCB 3, electronic components 4, and a rechargeable battery 8. A fan assembly 5 for blowing air is arranged on the fan main body 1; the first PCB 2 is arranged inside the fan main body 1 along the length direction of the fan main body 1, and the fan assembly 5 is electrically connected to the first PCB 2; the second PCB 3 is inserted into the first PCB 2 in an intersecting manner, and the second PCB 3 is electrically connected to the first PCB 2; the electronic components 4 are arranged on the first PCB 2 and/or the second PCB 3; and the rechargeable battery 8 is arranged inside the fan main body 1 and electrically connected to the first PCB 2.

A fan assembly 5 is arranged on the fan main body 1. The fan main body 1 includes a first housing 11 and a second housing 12. The fan assembly 5 includes a fan motor 51 and fan blades 52. A shaft hole 54 is formed on the first housing 11; the fan motor 51 is arranged inside the first housing 11, and a rotating shaft 53 of the fan motor 51 is inserted through and extends out of the shaft hole 54; and the fan blades 52 are arranged outside the first housing 11 and connected to the end of the rotating shaft 53 extending out of the shaft hole 54.

In some embodiments, the fan main body 1 may also be formed as a complete housing through an integrated molding process.

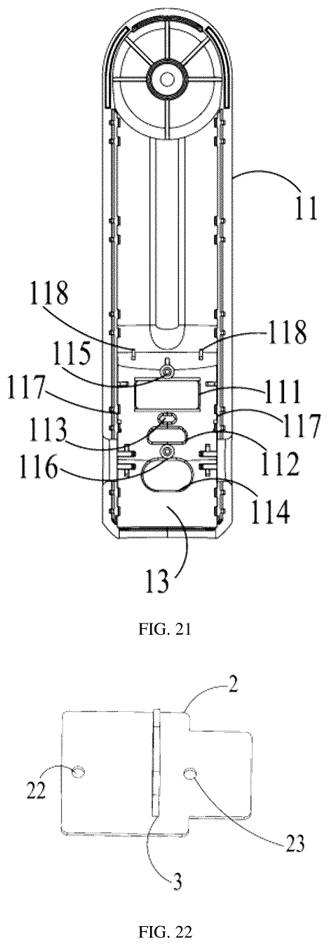

Refer to FIG. 21. FIG. 21 is a structural schematic diagram of the first housing according to this embodiment.

As shown in FIG. 21, a receiving cavity 13 is formed inside the fan main body 1. The first PCB 2 is arranged in the receiving cavity 13 along the length direction of the receiving cavity 13. The second PCB 3 is arranged between the first PCB 2 and the inner surface of the receiving cavity 13.

In some embodiments, when the fan main body 1 includes a first housing 11 and a second housing 12, the receiving cavity 13 is formed on the first housing 11, the first PCB 2 is arranged in the receiving cavity 13 along the length direction of the receiving cavity 13, and the second PCB 3 is arranged between the first PCB 2 and the inner surface of the first housing 11.

The spatial positional relationship between the first PCB 2 and the second PCB 3 is intersecting. Therefore, the first PCB 2 and the second PCB 3 may be inserted vertically, at an acute angle, or at an obtuse angle.

The electronic components 4 in this embodiment may be (but are not limited to) chips, resistors, capacitors, inductors, potentiometers, interface sockets 41, charging interfaces 42, LED signal lights 43, key switches 44, or the like.

The rechargeable battery 8 is arranged between the receiving cavity 13 and the fan assembly 5. In some embodiments, one end of the rechargeable battery 8 is mounted above the receiving cavity 13.

The first PCB 2 and the fan assembly 5 are electrically connected through wires or flexible printed circuits.

The first PCB 2 and the second PCB 3 are electrically connected through wires, flexible printed circuits, or soldering.

The rechargeable battery 8 and the first PCB 2 are electrically connected through wires or flexible printed circuits.

In the foregoing embodiment, the first PCB 2 and the second PCB 3 are arranged inside the fan main body 1. The first PCB 2 is arranged along the length direction of the fan main body 1. Since the fan main body 1 is relatively long, arranging the first PCB 2 along the length direction can most effectively utilize the space of the fan main body 1. The second PCB 3 is inserted into the first PCB 2 in an intersecting manner, so that the second PCB 3 does not need to occupy space in the length direction of the fan main body 1, but instead occupies the space between the fan main body 1 and the first fan main body 1, thereby improving utilization of the internal space of the fan main body 1. The provision of the first PCB 2 and the second PCB 3 increases the total area of the PCBs, reduces the arrangement density of the electronic components 4 in the fan main body 1, increases the heat dissipation space of the electronic components 4, improves the heat dissipation efficiency, and also reduces the electromagnetic interference intensity between the electronic components 4. In addition, since the first PCB 2 and the second PCB 3 intersect in space, the internal space of the fan main body 1 is reasonably utilized, thereby making the volume of the fan main body 1 smaller, and increasing the spatial distance between the electronic components 4 arranged on the first PCB 2 and the second PCB 3, thereby further reducing the electromagnetic interference intensity between the electronic components 4.

An insertion groove 21 is formed on the first PCB 2, and one end of the second PCB 3 is vertically inserted into the insertion groove 21.

Refer to FIG. 22. FIG. 22 is a schematic diagram of the connection structure between the first PCB and the second PCB according to this embodiment.

As shown in FIG. 22, in some embodiments, an insertion tongue 31 extends from the end of the second PCB 3 that is inserted into the first PCB 2, and the insertion tongue 31 is inserted into the insertion groove 21.

The first PCB 2 is provided with an insertion groove 21, and the second PCB 3 is inserted into the insertion groove 21. The insertion groove 21 can facilitate the insertion of the second PCB 3 into the first PCB 2. In addition, the second PCB 3 can be exposed on both sides of the first PCB 2 through the insertion groove 21, which facilitates fixing the second PCB 3 from both sides.

The second PCB 3 is fixedly connected to the first PCB 2 through soldering, and the circuits on the second PCB 3 are connected to the circuits on the first PCB 2 through soldering.

The second PCB 3 is fixedly soldered to the first PCB 2 by tin soldering. The soldering points of the tin soldering are located at the joints between the second PCB 3 and the insertion groove 21, and the soldering positions may be located at the joint on one side or at the joints on both sides.

The circuits on the second PCB 3 and the circuits on the first PCB 2 are also electrically connected through tin soldering.

Tin soldering can not only fix the second PCB 3 on the first PCB 2, but also connect the circuits between the first PCB 2 and the second PCB 3 through soldering, saving wires and making the electrical connection more stable.

In some embodiments, the fixing manner between the first PCB 2 and the second PCB 3 may also be (but not limited to) adhesive bonding, interference fit, or the like. When connected through adhesive bonding or interference fit, the first PCB 2 and the second PCB 3 are electrically connected through wires or flexible printed circuits.

In some embodiments, the first PCB 2 and the second PCB 3 do not need to be connected through the insertion tongue 31 and the insertion groove 21, and may be directly fixed by adhesive bonding or tin soldering.

A plurality of support frames 118 are arranged on the inner surface of the fan main body 1, and the plurality of support frames 118 abut against the first PCB 2. The plurality of support frames 118 are arranged around the first PCB 2. The support of the plurality of support frames 118 can make the assembly of the first PCB 2 more stable. In addition, the structure formed through the enclosure of the plurality of support frames 118 can position the first PCB 2, thereby facilitating the assembly of the first PCB 2.

A first fixing bracket 115 and a second fixing bracket 116 are arranged inside the fan main body 1, and the first PCB 2 is mounted on the first fixing bracket 115 and the second fixing bracket 116.

A first threaded hole (not shown) is formed on the first fixing bracket 115, and a second threaded hole (not shown) is formed on the second fixing bracket 116. A first fixing hole 22 is formed on the first PCB 2 at a position corresponding to the first threaded hole, and a second fixing hole 23 is formed on the first PCB 2 at a position corresponding to the second threaded hole. The first fixing hole 22 and the first threaded hole are fixed by a first screw 24, and the second fixing hole 23 and the second threaded hole are fixed by a second screw 25.

In some embodiments, the fixing manner between the first PCB 2 and the first fixing bracket 115 and the second fixing bracket 116 may be (but not limited to) adhesive fixing or riveting.

The provision of the first fixing bracket 115 and the second fixing bracket 116 can make the fixation of the first PCB 2 more stable.

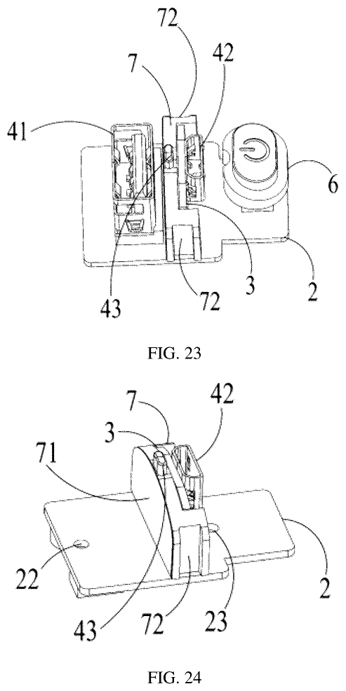

Refer to FIG. 23. FIG. 23 is a schematic diagram of the connection structure between the first PCB, the second PCB and the electronic components according to this embodiment.

As shown in FIG. 23, in some embodiments, the electronic components 4 include an interface socket 41. The interface socket 41 is connected to the first PCB 2. A first opening 111 is formed on the fan main body 1 at a position corresponding to the interface socket 41, and the interface socket 41 is communicated with the outside through the first opening 111.

The interface socket 41 is a USB interface socket 41. The interface socket 41 is fixedly connected to the first PCB 2 through soldering, and the interface socket 41 is used for charging an external electronic terminal. In this embodiment, the portable fan can be used as a power bank to charge an external electronic terminal, and the external electronic terminal is electrically connected to the interface socket 41 through a USB charging cable for charging.

In some embodiments, the electronic components 4 further include a charging interface 42. The charging interface 42 is connected to the second PCB 3. A second opening 112 is formed on the fan main body 1 at a position corresponding to the charging interface 42, and the charging interface 42 is communicated with the outside through the second opening 112.

In this embodiment, the charging interface 42 is a Type-C interface. However, the type of the charging interface 42 is not limited thereto. Depending on specific application scenarios, in some embodiments, the charging interface 42 is a USB interface.

The charging interface 42 is fixedly connected to the second PCB 3 through soldering. Fixing the charging interface 42 to the second PCB 3 can avoid the need for a bracket for placing the charging interface 42, simplify the fixing manner of the charging interface 42, and make the fixation of the charging interface 42 more stable.

The charging interface 42 is used for charging the rechargeable battery 8, and the rechargeable battery 8 can be charged by connecting to an external power source through a charging wire.

In some embodiments, the charging interface 42 may be fixed on the first PCB 2.

Refer to FIG. 24. FIG. 24 is a schematic diagram of the connection structure between the first PCB, the second PCB and some electronic components according to this embodiment.

As shown in FIG. 24, in some embodiments, the electronic components 4 further include an LED signal light 43. The LED signal light 43 is connected to the first PCB 2 or the second PCB 3. A third opening 113 is formed on the fan main body 1 at a position corresponding to the LED signal light 43, and the LED signal light 43 is communicated with the outside through the third opening 113.

The LED signal light 43 is fixed on the first PCB 2 through soldering. However, the fixing manner of the LED signal light 43 is not limited thereto. Depending on specific application scenarios, in some embodiments, the LED signal light 43 is fixed on the second PCB 3 through soldering.

The portable fan further includes a lamp holder 7, and the LED signal light 43 is clamped on the lamp holder 7. To prevent the LED signal light 43 from falling into the fan body from the third opening 113 after being squeezed by an external force, the lamp holder 7 is provided to support the LED signal light 43.

One end of the lamp holder 7 abuts against the first PCB 2, and the other end of the lamp holder 7 abuts against the inner surface of the fan main body 1. The mutual abutment between the lamp holder 7 and the first PCB 2 and the inner surface of the fan main body 1 can improve the stability of the lamp holder 7 and better support the LED signal light 43.

Clamping grooves 72 are formed on both sides of the lamp holder 7, and clamping members 117 are arranged on the fan main body 1 at positions corresponding to the clamping grooves 72. The clamping grooves 72 are engaged with the clamping members 117. The provision of the clamping grooves 72 on the lamp holder 7 can prevent the lamp holder 7 from tilting to the left and right sides, thereby making the lamp holder 7 more stable.

The LED signal light 43 has two metal pins, and the LED signal light 43 is connected to the first PCB 2 or the second PCB 3 through the two metal pins. A receiving groove for the two metal pins to pass through is formed on one side of the lamp holder 7, and the second PCB 3 is arranged in the receiving groove. This can maximize the use of space resources and make the portable fan more compact. In addition, the second PCB 3 and the lamp holder 7 can support each other, thereby improving the stability of the second PCB 3 and the lamp holder 7, and preventing them from tilting to the left and right sides.

A light blocking sheet 71 is covered on the lamp holder 7, and the light blocking sheet 71 is arranged on the side of the lamp holder 7 facing the interface socket 41. However, the position of the light blocking sheet 71 is not limited thereto. Depending on specific application scenarios, in some embodiments, the light blocking sheet 71 is covered on the receiving groove. The light blocking sheet 71 is a sheet-like structure made of (but not limited to) light-shielding cotton, plastic, or metal foil. The provision of the light blocking sheet 71 can prevent the light of the LED signal light 43 from leaking and affecting the overall appearance of the portable fan.

In some embodiments, the portable fan further includes a control button 6. A key switch 44 is arranged on the first PCB 2, the control button 6 abuts against the key switch 44, and a fourth opening 114 is formed on the fan body at a position corresponding to the control button 6, with the control button 6 arranged in the fourth opening 114.

### Embodiment 5

In hot summers, fans have become essential appliances for users to relieve heat. With the increasing demand for convenient use, fans that are lighter and more portable have gained growing popularity.

With the increasing portability of fans nowadays, in addition to the function of blowing air, to meet users'increasing needs for more usage scenarios, more and more functional components are integrated into fans. In the prior art, to facilitate the use of fans in dark environments, light-emitting elements are arranged on the fans. Specifically, a hole is formed on the fan housing, and the light-emitting element is directly assembled into the hole.

The applicant of the present application has found in research that in the prior art, since the light-emitting element is directly installed in the hole formed on the fan housing, the light-emitting element is prone to scratches and friction with external contact objects, resulting in damage. In addition, when subjected to external pressing, the light-emitting element may move inward into the fan housing, or even fall off from the hole of the fan housing and enter the inside of the fan housing, affecting the normal use of the light-emitting element. The displacement of the light-emitting element may also cause a gap between the light-emitting element and the hole on the fan housing, thereby allowing dust and other foreign objects to enter the fan housing and affecting the cleanliness of the environment inside the fan housing.

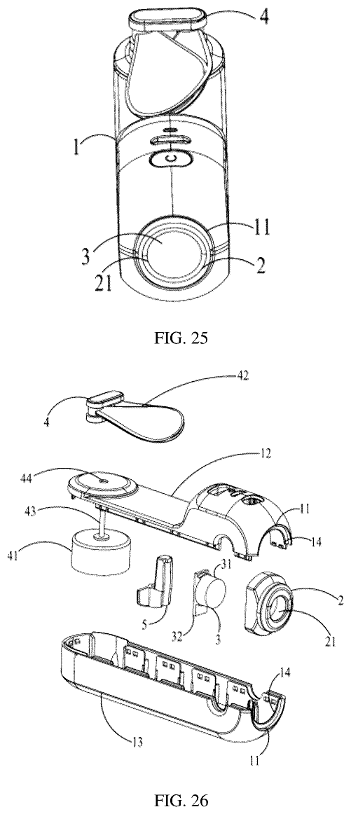

Refer to FIG. 25 and FIG. 26. FIG. 25 is a schematic diagram of an overall structure of a portable fan according to this embodiment; and FIG. 26 is an exploded structural schematic diagram of the portable fan according to this embodiment.

As shown in FIG. 25 and FIG. 26, the portable fan includes a fan main body 1, a flexible connecting member 2, and a light-emitting element 3. A fan assembly 4 is arranged on the fan main body 1; an assembly opening 11 is formed on the fan main body 1, and the flexible connecting member 2 is arranged on the assembly opening 11; a light source hole 21 is formed on the flexible connecting member 2, and the light-emitting element 3 is arranged in the light source hole 21; and a limiting member 5 is arranged inside the fan main body 1, and the limiting member 5 and the light-emitting element 3 abut against each other.

In this embodiment, the fan main body 1 includes a first housing 12 and a second housing 13, where the first housing 12 and the second housing 13 are connected through snap-fit. However, the connection manner between the first housing 12 and the second housing 13 is not limited thereto. Depending on specific application scenarios, in some embodiments, the first housing 12 and the second housing 13 may be fixed through (but not limited to) adhesive bonding, screw fixation, riveting, or the like.

The fan assembly 4 includes a fan motor 41 and fan blades 42. A shaft hole 44 is formed on the first housing 12; the fan motor 41 is arranged inside the first housing 12, and a rotating shaft 43 of the fan motor 41 is inserted through and extends out of the shaft hole 44; and the fan blades 42 are arranged outside the first housing 12 and connected to the end of the rotating shaft 43 extending out of the shaft hole 44.

In some embodiments, the fan main body 1 may be manufactured using an integrated molding technology, and the fan main body 1 is a non-detachable structure.

In this embodiment, the assembly opening 11 is formed at the end of the fan main body 1 facing away from the fan assembly 4, and the assembly opening 11 includes notches on the first housing 12 and the second housing 13. In some embodiments, when the fan main body 1 is manufactured using an integrated molding process, the assembly opening 11 is directly formed at the end of the fan main body 1.

The shape of the assembly opening 11 is circular. However, the shape of the assembly opening 11 is not limited thereto. Depending on specific application scenarios, the shape of the assembly opening 11 may be (but not limited to) polygonal, elliptical, racetrack-shaped, or the like.

The flexible connecting member 2 is made of soft rubber, silicone, or fluororubber.

The light-emitting element 3 may be (but not limited to) an LED lamp bead 31, a spherical bulb, a laser generator, an ultraviolet lamp, a colored lamp, or the like.

In the foregoing embodiment, the assembly opening 11 is formed on the fan main body 1, the assembly opening 11 is connected to the flexible connecting member 2, the light source hole 21 is formed on the flexible connecting member 2, and the light-emitting element 3 is arranged in the light source hole 21. The flexible connecting member 2 can protect the light-emitting element 3 arranged in the light source hole 21, thereby avoiding direct contact between the light-emitting element 3 and the external environment, and reducing the probability of damage to the light-emitting element 3 caused by scratches and friction. The limiting member 5 is arranged inside the fan main body 1, and the limiting member 5 and the light-emitting element 3 abut against each other. When the light-emitting element 3 is subjected to an external pressing force, the limiting member 5 will provide a supporting force to the light-emitting element 3, thereby avoiding the problem that the light-emitting element 3 retreats or falls from the light source hole 21 into the inside of the fan main body 1. In addition, due to the support of the limiting member 5, the light-emitting element 3 cannot retreat, and together with the close fit of the flexible connecting member 2, it is difficult for a gap to form between the light-emitting element 3 and the light source hole 21, thereby effectively preventing external dust and foreign objects from entering the fan main body 1 and ensuring the cleanliness inside the fan main body 1.

A clamping ring 14 is arranged in the assembly opening 11, a clamping groove 22 is formed on the flexible connecting member 2, and the flexible connecting member 2 is connected to the clamping ring 14 through the clamping groove 22.

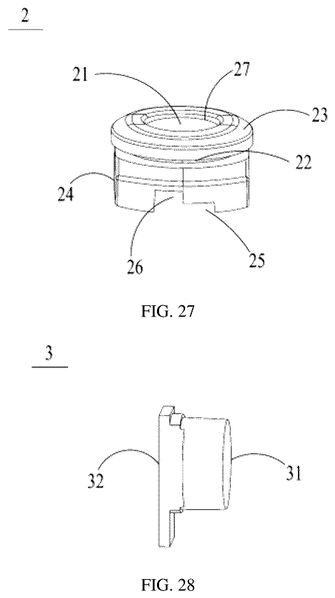

Refer to FIG. 27. FIG. 27 is a structural schematic diagram of the flexible connecting member according to this embodiment.

As shown in FIG. 27, a clamping groove 22 is formed on the flexible connecting member 2, and the clamping groove 22 is engaged with the clamping ring 14 on the assembly opening 11. After the clamping groove 22 and the clamping ring 14 are engaged, the connection between the flexible connecting member 2 and the assembly opening 11 is tighter, and when an external force acts on the flexible connecting member 2, the flexible connecting member 2 is not easy to fall off. Therefore, the provision of the clamping ring 14 and the clamping groove 22 can enhance the connection strength and stability between the flexible connecting member 2 and the fan main body 1.

The flexible connecting member 2 includes a first connecting part 23 and a second connecting part 24. The first connecting part 23 and the second connecting part 24 are respectively located on both sides of the clamping groove 22. One side surface of the first connecting part 23 is exposed outside the fan main body 1, the second connecting part 24 is located inside the fan main body 1, and the volume of the second connecting part 24 is larger than that of the first connecting part 23.

Specifically, the first connecting part 23 is arranged in a circular ring shape, and the second connecting part 24 is arranged in a racetrack shape. However, the shapes of the first connecting part 23 and the second connecting part 24 are not limited thereto, and may change with the shape of the fan main body 1. For example, when the shape of the fan main body 1 is a cuboid, the shapes of the first connecting part 23 and the second connecting part 24 may be square.

When an external force acts on the first connecting part 23 by pulling, the flexible connecting member 2 is prone to deformation and may be pulled out of the assembly opening 11 by the external force. Since the volume of the second connecting part 24 is larger than that of the first connecting part 23 and the second connecting part 24 is arranged inside the fan main body 1, when a large pulling force is applied, the second connecting part 24, due to its large volume, is difficult to be compressed to a size suitable for entering and exiting the assembly opening 11, thereby ensuring that the flexible connecting member 2 will not be pulled out. Therefore, the size ratio between the first connecting part 23 and the second connecting part 24 can reduce the probability of the flexible connecting member 2 being disengaged and improve the stability of the connection between the flexible connecting member 2 and the fan main body 1.

The flexible connecting member 2 extends into the light source hole 21 to form a limiting flange 27, and the limiting flange 27 abuts against the end of the light-emitting element 3 facing the external environment.

The provision of the limiting flange 27 can effectively prevent the light-emitting element 3 from falling out of the light source hole 21 and from the inside of the fan main body 1 to the outside. In addition, the limiting flange 27 can also prevent the light-emitting element 3 from protruding or bulging on the surface of the fan main body 1, or in other words, prevent the light-emitting element 3 from being exposed outside the flexible connecting member 2, thereby playing a buffering and protective role for the light-emitting element 3. For example, when the portable fan falls, if the flexible connecting member 2 comes into contact with the ground, since the light-emitting element 3 is restricted by the limiting flange 27 from protruding on the surface of the flexible connecting member 2, the flexible connecting member 2 can play a buffering role during the collision, protecting the light-emitting element 3 from damage.

The limiting flange 27 is arranged as an annular flange. However, the shape of the limiting flange 27 is not limited thereto. Depending on specific application scenarios, in some embodiments, the limiting flange 27 may be a protruding bump, a protruding block, an arc-shaped flange, or the like.

Refer to FIG. 28. FIG. 28 is a structural schematic diagram of the light-emitting element according to this embodiment.

As shown in FIG. 28, in some embodiments, the light-emitting element 3 includes an LED lamp bead 31 and a connecting plate 32. The LED lamp bead 31 is arranged on the connecting plate 32, the LED lamp bead 31 is inserted into the light source hole 21, and the limiting member 5 abuts against the connecting plate 32.

By arranging the LED lamp bead 31 on the connecting plate 32, since the surface of the connecting plate 32 is flat, when it abuts against the limiting member 5, the contact area is larger and the force is more evenly distributed, so it can withstand a larger abutting force. In addition, the provision of the connecting member avoids direct contact between the LED lamp bead 31 and the limiting member 5, better protecting the LED lamp bead 31.

The length of the connecting plate 32 is greater than the diameter of the light source hole 21, so that the connecting plate 32 is mounted on both sides of the light source hole 21.

Since the length of the connecting plate 32 is greater than the diameter of the light source hole 21, both ends of the connecting plate 32 can span across the light source hole 21. This structure can further prevent the light-emitting element 3 from falling out of the light source hole 21. The combination of the connecting plate 32 and the limiting flange 27 provides double resistance to the light-emitting element 3 when pulled by an external force, achieving a better protective effect.

A receiving groove 25 is formed on the flexible connecting member 2, and the connecting plate 32 is arranged in the receiving groove 25. The provision of the receiving groove 25 can prevent the connecting plate 32 from protruding on the surface of the flexible connecting member 2, reasonably utilize the available space structure, make the spatial layout of the connecting plate 32 and the flexible connecting member 2 more reasonable, and improve the space utilization inside the fan main body 1. In addition, the provision of the receiving groove 25 can also limit the position of the connecting member, thereby avoiding the possibility of the connecting member shaking under the action of an external force, thereby ensuring that the light-emitting element 3 does not shake and improving the stability of the light-emitting element 3.

A wire groove 26 is recessed at one end of the receiving groove 25 of the flexible connecting member 2. The LED lamp bead 31 is electrically connected to the connecting plate 32, and the wires on the connecting plate extend out of the flexible connecting member from the wire groove.

The provision of the wire groove 26 allows the wires connected to the light-emitting element 3 to pass through the wire groove 26 between the connecting plate 32 and the flexible connecting member 2, reasonably utilizing the spatial structure of the flexible connecting member 2 and the connecting plate 32 and improving the space utilization. Since the LED lamp bead 31 is electrically connected to the connecting plate 32, the wires only need to be connected to the connecting plate 32 to supply power to the LED lamp bead 31, which shortens the length of the wires. In addition, the wires do not need to be directly connected to the LED lamp bead 31, but are fixed on the connecting plate 32 through soldering, thereby making the connection of the wires more stable. The electrical connection between the connecting plate 32 and the LED lamp bead 31 allows them to be fixedly connected through soldering, which improves the stability of the electrical connection between the connecting plate 32 and the LED lamp bead 31 and also enhances the stability of the physical connection between them.

The connecting plate 32 is made of a metal plate. However, the material of the connecting plate 32 is not limited thereto. Depending on specific application scenarios, in some embodiments, the connecting plate 32 may be made of (but not limited to) plastic, wood, fiberboard, or other materials. For example, when there is no electrical connection between the connecting plate 32 and the LED lamp bead 31, the connecting plate 32 may be made of hard plastic.

One end of the limiting member 5 is connected to the inner surface of the fan main body 1, and the other end of the limiting member 5 is free. This structure of the limiting member 5 facilitates the disassembly of the fan main body 1.

The connection relationship between the limiting member 5 and the fan main body 1 may be (but not limited to) integral molding, adhesive bonding, snap-fit, screw connection, or riveting.

Specifically, one end of the limiting member 5 is connected to the inner surface of the second housing 13, and the other end extends toward the first housing 12 and is free.

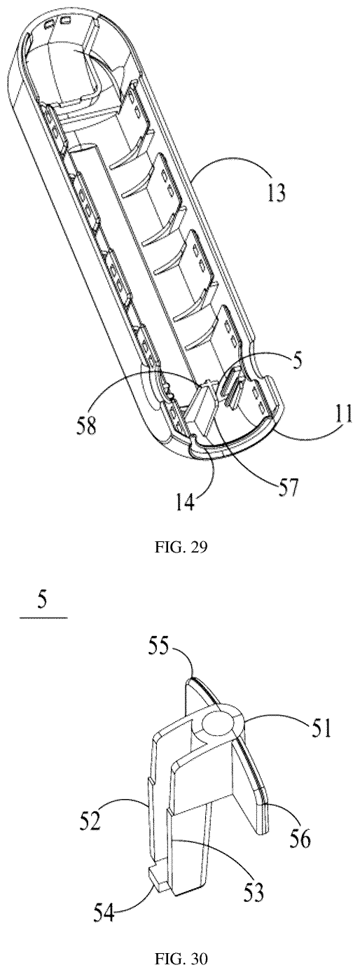

Refer to FIG. 29. FIG. 29 is a structural schematic diagram of the second housing and the first type of limiting member according to this embodiment.

As shown in FIG. 29, the limiting member 5 includes a first limiting plate 57 and a second limiting plate 58, where the first limiting plate 57 and the second limiting plate 58 are cross-connected. The first limiting plate 57 abuts against the light-emitting element 3.

The cross structure of the first limiting plate 57 and the second limiting plate 58 can improve the spatial stability of the limiting member 5, thereby avoiding the problem that a single limiting plate bends due to lack of lateral structural support when subjected to a lateral force, and thus improving the spatial stability of the limiting member 5. In addition, the cross structure allows the first limiting plate 57 to transmit the force to the second limiting plate 58 after being stressed, improving the force-bearing strength of the first limiting plate 57.

Refer to FIG. 30. FIG. 30 is a second structural schematic diagram of the limiting member according to this embodiment.

As shown in FIG. 30, in some embodiments, the limiting member 5 includes a limiting main body 51, where the limiting main body 51 is detachably connected to the fan main body 1. The detachable connection between the limiting main body 51 and the fan main body 1 facilitates partial replacement of the limiting main body 51 and improves the replaceability of the components of the portable fan.

A first abutting strip 52 and a second abutting strip 53 protrude from the two side edges of the limiting main body 51 facing the light-emitting element 3, and an abutting block 54 protrudes from the end of the free end of the limiting main body 51 toward the light-emitting element 3. The first abutting strip 52, the second abutting strip 53, and the abutting block 54 respectively abut against the light-emitting element 3.

A total of three abutting structures, namely the first abutting strip 52, the second abutting strip 53, and the abutting block 54, protrude from the side of the limiting main body 51 facing the connecting plate 32 or the light-emitting element 3, and the three abutting structures are distributed in a triangular configuration. The provision of the first abutting strip 52, the second abutting strip 53, and the abutting block 54 increases the contact area between the limiting member 5 and the connecting plate 32 or the light-emitting element 3, improving the stability of the abutment.

A first wing part 55 and a second wing part 56 extend from both sides of the limiting main body 51. A first limiting groove (not shown) and a second limiting groove (not shown) are respectively formed on the two opposite side walls of the fan main body 1. The first wing part 55 is inserted into the first limiting groove, and the second wing part 56 is inserted into the second limiting groove.

The insertion structure between the first wing part 55, the second wing part 56 and the first limiting groove, the second limiting groove can restrict the limiting main body 51 from deflecting in a manner that damages the existing posture of the limiting main body 51 when subjected to a lateral force, thereby increasing the spatial stability of the posture of the limiting main body 51. In addition, when the light-emitting element 3 is subjected to a pressing force, the first limiting groove and the second limiting groove, together with the connection part between the limiting main body 51 and the fan main body 1, form a three-point force-bearing structure, which improves the supporting force of the limiting member 5 on the light-emitting element 3 and the force-bearing upper limit of the limiting member 5.

The connection manner between the limiting main body 51 and the fan main body 1 is screw fixation. For example, a connecting screw hole (not labeled) is formed on the limiting main body 51, and a threaded hole (not shown) is formed on the fan main body 1. A screw passes through the connecting screw hole and the threaded hole to detachably fix the limiting main body 51 on the fan main body 1. However, the connection manner between the limiting main body 51 and the fan main body 1 is not limited thereto. Depending on specific application scenarios, in some embodiments, the limiting main body 51 and the fan main body 1 are connected through snap-fit or interference fit.

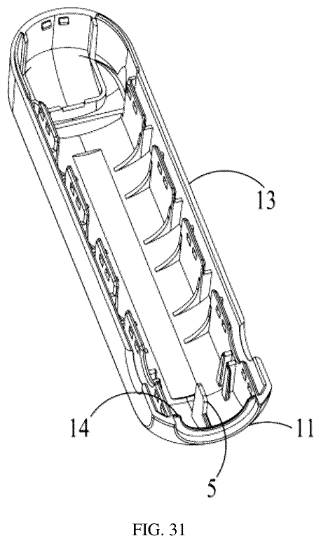

Refer to FIG. 31. FIG. 31 is a structural schematic diagram of the second housing and the third type of limiting member according to this embodiment.

As shown in FIG. 31, in some embodiments, the limiting member 5 is arranged as an inverted “L”-shaped sheet. The inverted “L”-shaped structure can make the limiting member 5 and the second housing 13 have a larger contact area, increasing the physical strength of the limiting member 5.

### Embodiment 6

Portable fans are favored by users due to their small size and ease of carrying. The applicant of the present application has found in research that the connection between the rotating shaft and the fan blades of a portable fan generally adopts a locking mechanism to lock the rotating shaft and the fan blades, which makes the disassembly and assembly of the fan blades very inconvenient. In addition, for a portable fan, under the condition that the rotation speed of the fan motor is constant, the air outlet efficiency is mainly related to the area of the fan blades. To pursue air outlet efficiency, the area of the fan blades is usually made large, so the size of the fan blades limits the volume of the portable fan.

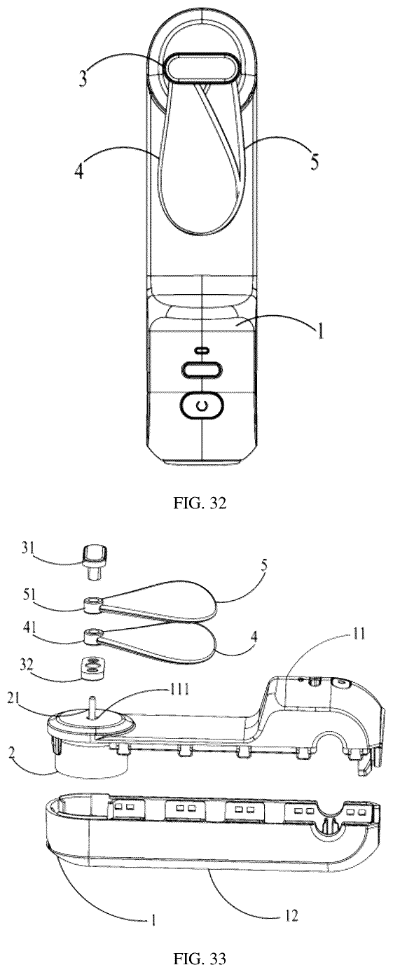

Refer to FIG. 32 and FIG. 33. FIG. 32 is an overall structural schematic diagram of the portable fan according to this embodiment; and FIG. 33 is an exploded structural schematic diagram of the portable fan according to this embodiment.

As shown in FIG. 32 and FIG. 33, the portable fan includes a fan main body 1, a blade base 3, a first blade 4, and a second blade 5. A fan motor 2 is arranged inside the fan main body 1, and one end of a rotating shaft 21 of the fan motor 2 extends out of the fan main body 1; the blade base 3 is connected to the end of the rotating shaft 21 extending out of the fan main body 1 by interference fit, and there is a gap between the blade base 3 and the fan main body 1; the first blade 4 and the second blade 5 are rotatably connected to the blade base 3; and the relative states of the first blade 4 and the second blade 5 include a receiving state and a rotating state. In the receiving state, the first blade 4 and the second blade 5 are stacked on each other; and in the rotating state, the first blade 4 and the second blade 5 are centrosymmetric around the rotating shaft 21.

The fan main body 1 includes a first housing 11 and a second housing 12. A shaft hole 111 is formed on the first housing 11; the fan motor 2 is arranged on the first housing 11, and the rotating shaft 21 of the fan motor 2 is inserted through and extends out of the shaft hole 111; and the blade base 3 is arranged outside the first housing 11 and connected to the end of the rotating shaft 21 extending out of the shaft hole 111.

The first housing 11 and the second housing 12 are connected through snap-fit. However, the connection manner between the first housing 11 and the second housing 12 is not limited thereto. Depending on specific application scenarios, in some embodiments, the first housing 11 and the second housing 12 may also be connected through (but not limited to) adhesive bonding, riveting, screw connection, interference fit insertion, or the like.

In some embodiments, the fan main body 1 may also be formed as a complete housing through an integrated molding process.

The blade base 3 is arranged in a racetrack shape. However, the overall structure of the blade base 3 is not limited thereto. Depending on specific application scenarios, in some embodiments, the blade base 3 may be arranged as (but not limited to) circular, elliptical, heart-shaped, triangular, quadrilateral, or other polygonal shapes.

A total of two blades, namely the first blade 4 and the second blade 5, are arranged on the blade base 3. However, the quantity of blades on the blade base 3 is not limited thereto. Depending on specific application scenarios, in some embodiments, the quantity of blades on the blade base 3 may be (but not limited to) 3, 4, 5, or more.

In the foregoing embodiment, the fan motor 2 is arranged inside the fan main body 1, and the blade base 3 connected to the fan blades is arranged outside the fan main body 1. The blade base 3 and the rotating shaft 21 of the fan motor 2 are connected through interference fit, which facilitates the disassembly and assembly of the fan blades. In addition, the blade base 3 is rotatably connected to the first blade 4 and the second blade 5, so the first blade 4 and the second blade 5 can rotate around their connection positions with the blade base 3. This structure allows the first blade 4 and the second blade 5 to be in the receiving state when not in use. In the receiving state, the first blade 4 and the second blade 5 are stacked, which reduces the overall volume of the portable fan and makes the portable fan more compact. When the fan motor 2 rotates, under the action of inertia, the first blade 4 and the second blade 5 form a centrosymmetric structure around the rotating shaft 21, so that the diameter of the first blade 4 and the second blade 5 in the rotating circumferential direction becomes larger, the coverage area of the first blade 4 and the second blade 5 is larger, and the air outlet efficiency is improved. In addition, due to the gap between the blade base 3 and the fan main body 1, no physical friction occurs between the blade base 3 and the fan main body 1, which improves the air outlet efficiency. Moreover, the gap between the blade base 3 and the fan main body 1 can serve as an air inlet channel for the first blade 4 and the second blade 5, thereby further improving the blowing efficiency of the portable fan.

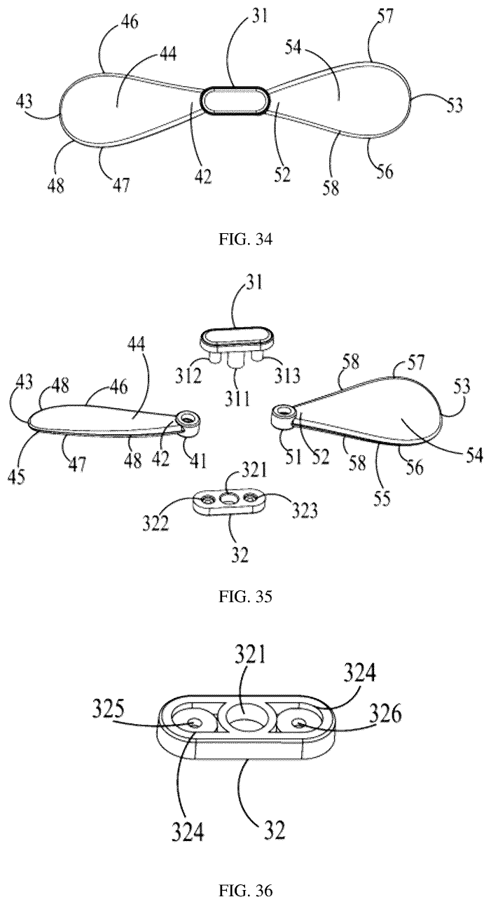

Refer to FIG. 34. FIG. 34 is a schematic structural diagram of the fan blade base in a rotating state according to this embodiment.

As shown in FIG. 34, the fan blade base 3 includes a mounting seat 31. A connecting sleeve 311 is arranged on the mounting seat 31, and a connecting hole (not shown) is provided in the connecting sleeve 311. The connecting sleeve 311 is connected to an end of the rotating shaft 21 extending out of the fan main body 1 through the connecting hole in an interference fit manner.

The mounting seat 31 is arranged in a racetrack shape. However, the overall configuration of the mounting seat 31 is not limited thereto. Depending on specific application scenarios, in some embodiments, the mounting seat 31 may be arranged as (but not limited to) circular, elliptical, heart-shaped, triangular, quadrilateral, or other polygonal shapes.

An end of the rotating shaft 21 connected to the connecting hole is arranged in a cylindrical shape. However, the shape of the end portion of the rotating shaft 21 is not limited thereto. Depending on specific application scenarios, in some embodiments, the shape of the end portion of the rotating shaft 21 may be (but not limited to) an ellipse, a racetrack shape, a triangle, a quadrilateral, a pentagon, or other polygons. The shape of the connecting hole can be changed according to the shape of the rotating shaft 21, and is set to a shape corresponding to the shape of the rotating shaft 21.

The provision of the connecting sleeve 311 increases the contact area between the connecting hole and the end portion of the rotating shaft 21, and improves the stability of the connection between the mounting base and the rotating shaft 21.

Refer to FIG. 35. FIG. 35 is an exploded schematic structural diagram of the fan blade base according to this embodiment.

As shown in FIG. 35, the fan blade base 3 further includes a first rotating shaft 312 and a second rotating shaft 313. Both the first rotating shaft 312 and the second rotating shaft 313 are connected to the mounting seat 31, and the first rotating shaft 312 and the second rotating shaft 313 are respectively arranged on two sides of the connecting sleeve 311. A first shaft ring 41 is arranged at a blade tail 42 of the first blade 4, and a second shaft ring 51 is arranged at a blade tail 52 of the second blade 5. The first shaft ring 41 is sleeved on the first rotating shaft 312, and the second shaft ring 51 is sleeved on the second rotating shaft 313.

An inner diameter of the first shaft ring 41 is larger than an outer diameter of the first rotating shaft 312, and an inner diameter of the second shaft ring 51 is also larger than an outer diameter of the second rotating shaft 313, so that the first blade 4 can rotate around the first rotating shaft 312 and the second blade 5 can rotate around the second rotating shaft 313.

The first rotating shaft 312 and the second rotating shaft 313 are arranged on two sides of the connecting sleeve 311, so that the center of gravity of the fan blade base 3 is distributed on the connecting sleeve 311, and the rotation stability of the first blade 4 and the second blade 5 is higher.

Refer to FIG. 36. FIG. 36 is a schematic structural diagram of a limiting plate according to this embodiment.

As shown in FIG. 36, the fan blade base 3 further includes a limiting plate 32. The limiting plate 32 is arranged between the mounting seat 31 and the fan main body 1. An insertion hole 321 is provided in the limiting plate 32. An end of the connecting sleeve 311 connected to the rotating shaft 21 is inserted into the insertion hole 321, and the limiting plate 32 is detachably connected to the first rotating shaft 312 and the second rotating shaft 313.

The provision of the limiting plate 32 can prevent the first blade 4 and the second blade 5 from falling off from the first rotating shaft 312 and the second rotating shaft 313. In addition, the limiting plate 32 limits the positions of the first blade 4 and the second blade 5, so as to avoid an excessive movement range of the first blade 4 and the second blade 5, which may cause jitter of the first blade 4 and the second blade 5 due to uneven position distribution when the fan rotates, thereby making the fan rotate more stably and improving the air outlet efficiency.

The limiting plate 32 is arranged in a racetrack shape. However, the overall configuration of the limiting plate 32 is not limited thereto. Depending on specific application scenarios, in some embodiments, the limiting plate 32 may be arranged as (but not limited to) circular, elliptical, heart-shaped, triangular, quadrilateral, or other polygonal shapes.

In some embodiments, the limiting plate 32 can be replaced with a retaining edge. Specifically, a free end of the first rotating shaft 312 and a free end of the second rotating shaft 313 are laterally protruded to form a retaining edge, and a diameter of the retaining edge is larger than inner diameters of the first shaft ring 41 and the second shaft ring 51.

A first insertion groove 322 and a second insertion groove 323 are provided on a side of the limiting plate 32 facing the mounting seat 31. The first insertion groove 322 and the second insertion groove 323 are respectively arranged on two sides of the insertion hole 321. The first rotating shaft 312 is inserted into the first insertion groove 322, and the second rotating shaft 313 is inserted into the second insertion groove 323. A first through hole 325 is provided in the first insertion groove 322, and a second through hole 326 is provided in the second insertion groove 323. A first threaded hole (not shown) corresponding to the first through hole 325 is provided on the first rotating shaft 312, and a second threaded hole (not shown) corresponding to the second through hole 326 is provided on the second rotating shaft 313. The first through hole 325 and the first threaded hole are connected through a first screw (not shown), and the second through hole 326 and the second threaded hole are connected through a second screw (not shown).

The provision of the first insertion groove 322 and the second insertion groove 323 facilitates alignment of the first rotating shaft 312, the second rotating shaft 313 and the limiting plate 32 during assembly, so that the assembly of the fan blade base 3 is more convenient. In addition, the provision of the first insertion groove 322 and the second insertion groove 323 enables the first rotating shaft 312 and the second rotating shaft 313 to extend into them, which reasonably utilizes the space structure and makes the structure of the fan blade base 3 more compact. The provision of the first insertion groove 322 and the second insertion groove 323 can also share lateral external forces applied to the first rotating shaft 312 and the second rotating shaft 313, so as to avoid a problem of low lateral force strength caused by the first rotating shaft 312 and the second rotating shaft 313 being only connected to the mounting seat 31, and improve the physical strength of the first rotating shaft 312 and the second rotating shaft 313, so that they can withstand large lateral centrifugal forces generated by the first blade 4 and the second blade 5 due to high-speed rotation when the fan motor 2 rotates at a high speed.

An edge of a surface of the limiting plate 32 facing the fan main body 1 is raised to form an anti-protrusion retaining edge 324, and a gap is provided between the limiting plate 32 and the fan main body 1. To prevent the connecting sleeve 311, the first screw or the second screw from protruding on the surface of the limiting plate, a side of the limiting plate 32 facing the fan main body 1 extends toward the fan main body 1 to form the anti-protrusion retaining edge 324. Since the fan blade base 3 needs to rotate at a high speed along with the fan motor 2 when the portable fan is in an operating state, if a foreign object protrudes on the fan blade base 3, aerodynamic noise will be generated due to friction with air during high-speed rotation. The provision of the anti-protrusion retaining edge 324 can prevent the foregoing structure from protruding on the surface of the limiting plate. Therefore, the provision of the anti-protrusion retaining edge 324 can effectively reduce the fan noise of the portable fan. In addition, the gap between the limiting plate 32 and the fan main body 1 can avoid friction between the fan main body 1 and the limiting plate 32, and improve the rotation efficiency and air outlet efficiency of the portable fan. The gap between the fan main body 1 and the limiting plate 32 can also serve as an air inlet channel of the first blade 4 and the second blade 5 at positions of the blade tails 42, 52, which improves the air inlet efficiency of the portable fan.

The limiting plate 32 is detachably connected to the first rotating shaft 312 and the second rotating shaft 313, so that the limiting plate 32 can rotate synchronously with the mounting seat 31, thereby preventing the limiting plate 32 from displacing along an extending direction of the rotating shaft 21 and contacting the fan main body 1, and improving the overall rotation efficiency of the fan blade base 3.

In some embodiments, the detachable connection between the limiting plate 32 and the first rotating shaft 312 and the second rotating shaft 313 can be realized by an interference fit between the first rotating shaft 312 and the first insertion groove 322 and an interference fit between the second rotating shaft 313 and the second insertion groove 323. However, the detachable connection manner of the limiting plate 32 with the first rotating shaft 312 and the second rotating shaft 313 is not limited thereto. Depending on specific application scenarios, in some embodiments, a claw is arranged on the first rotating shaft 312, and a snap-fit structure mating with the claw is arranged in the first insertion groove 322. Similarly, a claw is also arranged on the second rotating shaft 313, and a snap-fit structure mating with the claw is also arranged in the second insertion groove 323, so that the first rotating shaft 312 is snapped into the first insertion groove 322 and the second rotating shaft 313 is snapped into the second insertion groove 323.

Both the first blade 4 and the second blade 5 include: windward surfaces 44, 54 and leeward surfaces 45, 55. Edge positions 58 where the windward surfaces 44, 54 are connected to the leeward surfaces 45, 55 are all arranged in an arc shape.

Side surfaces of the first blade 4 and the second blade 5 facing the fan main body 1 are the leeward surfaces 45, 55, and side surfaces of the first blade 4 and the second blade 5 facing away from the fan main body 1 are the windward surfaces 44, 54. Positions where the windward surfaces 44, 54 are connected to the leeward surfaces 45, 55 are side edges of the first blade 4 and the second blade 5. By arranging the side edges of the first blade 4 and the second blade 5 into an arc shape, the cutting abilities of the first blade 4 and the second blade 5 are reduced, so that when the first blade 4 and the second blade 5 come into contact with a human body in a rotating state, the human body will not be scratched due to excessively sharp side edges, thereby improving the use safety of the portable fan.

The windward surfaces 44, 54 are concave to form an inner arc-shaped surface, and the leeward surfaces 45, 55 are convex to form an outer arc-shaped surface. Since the first blade 4 and the second blade 5 need to push air when rotating, the windward surfaces 44, 54 being concave to form the inner arc-shaped surface can increase a contact area between the first blade 4 and the second blade 5 and air, and improve the pushing efficiency on the air. In addition, the inner arc-shaped surface has a concave binding force on the air, which can better drive the air to rotate and give higher initial velocity to the contacted air, thereby further improving the air outlet efficiency of the first blade 4 and the second blade 5. The leeward surfaces 45, 55 being convex to form the outer arc-shaped surface can reduce resistance of the air to the first blade 4 and the second blade 5, and improve the rotation efficiency of the first blade 4 and the second blade 5. In addition, the convex surface areas of the leeward surfaces 45, 55 are increased. When the first blade 4 and the second blade 5 rotate, the air flow velocities at the leeward surfaces 45, 55 are high and the air pressures are low, which will form an air pressure difference at positions where the leeward surfaces 45, 55 have rotated past. The air pressure difference will make the air flows behind the leeward surfaces 45, 55 flow toward the leeward surfaces 45, 55 and extending directions of the leeward surfaces 45, 55, thereby forming an air flow facing a direction directly opposite to the first blade 4 and the second blade 5. Therefore, during rotation of the first blade 4 and the second blade 5, in addition to the windward surfaces 44, 54 pushing the air flow, the leeward surfaces 45, 55 also have a blowing effect, which improves the air outlet efficiency of the first blade 4 and the second blade 5.

Both the first blade 4 and the second blade 5 include: first blade edges 46, 56 and second blade edges 47, 57. Both the first blade edges 46, 56 and the second blade edges 47, 57 are tilted outward away from the fan main body 1, and tilting heights of the second blade edges 47, 57 are greater than tilting heights of the first blade edge 46, 56. Since during rotation of the first blade 4 and the second blade 5, the first blade edges 46, 56 first cut the air, and then the windward surfaces 44, 54 and the second blade edges 47, 57 push the air, when the tilting heights of the second blade edges 47, 57 are greater than the tilting heights of the first blade edges 46, 56, wind resistance on the first blade edges 46, 56 can be reduced, and binding forces of the second blade edges 47, 57 on the air can be improved. The design of a difference in tilting heights between the first blade edges 46, 56 and the second blade edges 47, 57 are more in line with aerodynamics, and effectively improves the air outlet efficiency of the portable fan.

Radians of the first blade edges 46, 56 are smaller than radians of the second blade edges 47, 57. Along extending directions of the first blade 4 and the second blade 5, the radians of the first blade edges 46, 56 are smaller than the radians of the second blade edges 47, 57. According to the foregoing description, during rotation of the first blade 4 and the second blade 5, the first blade edges 46, 56 are used for cutting air, and the second blade edges 47, 57 are used for pushing air. By designing the radians of the first blade edges 46, 56 to be smaller, contact area between the first blade edges 46, 56 and the air can be reduced, so that the first blade edges 46, 56 can cut the air better. By designing the radians of the second blade edges 47, 57 to be larger, contact area between the second blade edges 47, 57 and the air can be increased, binding forces of the second blade edges 47, 57 on the air can be improved, and the air can be pushed better. The design of a change in radians between the first blade edges 46, 56 and the second blade edges 47, 57 can further reduce wind resistance on the first blade 4 and the second blade 5, and improve the blowing efficiency of the first blade 4 and the second blade 5.

Both the first blade 4 and the second blade 5 include: blade tails 42, 52 and blade tips 43, 53. Thicknesses of the first blade 4 and the second blade 5 both gradually decrease along a direction from the blade tails 42, 52 to the blade tips 43, 53. Since the first blade 4 and the second blade 5 are designed to have a structure with smaller areas at the blade tails 42, 52 and larger areas at the blade tips 43, 53, the change in thicknesses of the first blade 4 and the second blade 5 can make the overall mass distribution of the first blade 4 and the second blade 5 more uniform, and achieve better balance. In addition, when the first blade 4 and the second blade 5 rotate, although the blade tails 42, 52 and the blade tips 43, 53 maintain the same angular velocity, linear velocities of different parts of the first blade 4 and the second blade 5 gradually increase along the direction from the blade tails 42, 52 to the blade tips 43, 53. Therefore, the thickness gradually decreasing from the blade tails 42, 52 to the blade tips 43, 53 can gradually reduce a contact area between blade edges and the air, thereby gradually reducing wind resistance applied to different parts along the direction from the blade tails 42, 52 to the blade tips 43, 53. Combined with changes in angular velocities of different parts during rotation of the first blade 4 and the second blade 5, the edge thickness is changed correspondingly, which can balance wind resistance applied to edges from the blade tails 42, 52 to the blade tips 43, 53 during rotation of the first blade 4 and the second blade 5, and avoid damage to the first blade 4 and the second blade 5 caused by uneven wind resistance during rotation of the first blade 4 and the second blade 5.

1. A portable fan, comprising:
a first housing, wherein a fan assembly is arranged on the first housing; and
a second housing, wherein the second housing is fastened onto the first housing; and
an edge of the first housing protrudes toward the second housing to form an insertion member, a plurality of first engaging members are arranged on the insertion member, a clamping member is arranged in the second housing, a first insertion groove is formed between the clamping member and an inner surface of the second housing, a plurality of second engaging members mating with the plurality of first engaging members are arranged on the clamping member, the insertion member is inserted into the first insertion groove, and the plurality of first engaging members are engaged with the plurality of second engaging members in a mating manner.

2. The portable fan according to claim 1, wherein the insertion member comprises a first insertion plate, the first insertion plate is arranged along a length direction of the first housing, and the plurality of first engaging members are arranged on the first insertion plate.

3. The portable fan according to claim 2, wherein the insertion member comprises a plurality of insertion heads, and the plurality of insertion heads are spaced apart on the first insertion plate.

4. The portable fan according to claim 3, wherein every two of the plurality of first engaging members are arranged as a pair below each of the plurality of insertion heads; or
a guide piece is further arranged on the insertion member, the guide piece is arranged on a side of the first insertion plate facing away from the clamping member, and the guide piece extends from an edge of the first housing to a side edge of the first insertion plate facing the second housing, and gradually becomes smaller along an extending direction.

5. The portable fan according to claim 1, wherein the clamping member comprises a plurality of first clamping plates, and the plurality of first clamping plates are spaced apart along a length direction of the second housing.

6. The portable fan according to claim 5, wherein every two of the plurality of second engaging members are arranged as a pair on each of the plurality of first clamping plates; or
a connecting plate is arranged on both sides of each of the plurality of first clamping plates, wherein one end of the connecting plate is connected to the first clamping plate, the other end of the connecting plate is connected to the inner surface of the second housing, and a height of the connecting plate is lower than a height of the first clamping plate.

7. The portable fan according to claim 1, wherein second insertion grooves are provided in the first housing on two sides of the fan assembly, a second insertion plate mating with the second insertion grooves protrudes from an edge of the second housing at positions corresponding to the second insertion grooves, and both the second insertion grooves and the second insertion plate are curved in an arc shape along a circumferential direction of the fan assembly.

8. The portable fan according to claim 1, wherein at an end edge of the first housing at an end at which the fan assembly is arranged, a second clamping plate protrudes toward the second housing, a third engaging member is arranged on the second clamping plate, a fourth engaging member mating with the third engaging member is formed on the inner surface of the second housing at a position corresponding to the third engaging member, and the second clamping plate is curved in an arc shape along the circumferential direction of the fan assembly.

9. The portable fan according to claim 8, wherein a first limiting plate and a second limiting plate are respectively arranged on two sides of the fourth engaging member in the second housing, and the second clamping plate is arranged between the first limiting plate and the second limiting plate.

10. The portable fan according to claim 9, wherein two guide tongues protrude from a side edge of the second clamping plate facing the first housing, and a gap is left between the two guide tongues; or
a cut surface is provided on a side of the first limiting plate and the second limiting plate facing the fan assembly, so that the first limiting plate and the second limiting plate are attached to a surface of the fan assembly.

11. A portable fan, comprising:
a first housing, wherein a shaft hole is formed on the first housing;
a fan motor arranged in the first housing, wherein a rotating shaft of the fan motor is inserted through and extends out of the shaft hole;
fan blades arranged outside the first housing and connected to an end of the rotating shaft extending out of the shaft hole;
and a second housing connected to the first housing;
wherein a fixing bracket is arranged on the second housing, and the fixing bracket abuts against the fan motor, so that the first housing and the second housing clamp and fix the fan motor.

12. The portable fan according to claim 11, wherein
a main body of the fan motor is cylindrical, and the rotating shaft has one end arranged inside the fan motor and another end extending out of the fan motor.

13. The portable fan according to claim 12, wherein
an end of the fan motor facing the first housing protrudes to form a first boss, the rotating shaft passes through the first boss, an inner surface of the first housing facing the fan motor forms a receiving ring mating with the first boss, the receiving ring is in communication with the shaft hole, and the first boss extends into the receiving ring.

14. The portable fan according to claim 11, wherein
a flexible connecting ring is arranged between the fan motor and an inner surface of the first housing, one end of the flexible connecting ring is adhesively connected to the first housing, and the other end of the flexible connecting ring is adhesively connected to the fan motor.

15. A portable fan, comprising:
a fan main body provided with a fan blade;
a receiving housing defining a storage cavity configured to receive the fan main body, wherein one end of the receiving housing is provided with two connecting ears oppositely arranged, the two connecting ears being rotatably connected to the fan main body, respectively; and
an electronic display screen disposed on a surface of the fan main body facing the receiving housing, wherein the electronic display screen is configured to display a gear level of a rotation speed of the fan blade.

16. The portable fan according to claim 15, wherein
one end of the fan main body defines a first rotating shaft hole and a second rotating shaft hole;
the receiving housing is provided with a first rotating shaft and a second rotating shaft respectively mating with the first rotating shaft hole and the second rotating shaft hole; and a first limiting member and a second limiting member are respectively arranged in the fan main body, the first limiting member abuts against the first rotating shaft and the second limiting member abuts against the second rotating shaft to maintain a relative spatial form between the fan main body and the receiving housing.

17. The portable fan according to claim 16, wherein
the fan main body comprises a first housing and a second housing, and a fan assembly is arranged on the fan main body;
wherein the fan assembly comprises a fan motor and the fan blade, the fan motor is arranged in the first housing, a motor shaft hole is formed on the first housing, and a motor rotating shaft of the fan motor is inserted through and extends out of the motor shaft hole to connect to the fan blade.

18. The portable fan according to claim 17, wherein
the first rotating shaft hole and the second rotating shaft hole are formed at a junction of the first housing and the second housing.

19. The portable fan according to claim 18, wherein
two lugs extend from an end of the receiving housing connected to the fan main body;
wherein the first rotating shaft and the second rotating shaft are respectively provided on the two lugs to mate with the first rotating shaft hole and the second rotating shaft hole.

20. The portable fan according to claim 19, wherein
the first rotating shaft is inserted into the first rotating shaft hole, and the second rotating shaft is inserted into the second rotating shaft hole;
wherein the first limiting member and the second limiting member respectively abut against the first rotating shaft and the second rotating shaft.
